(19) United States
(12) Patent Application Publication
(10) Pub. No.: US 2025/0119907 A1
(43) Pub. Date: Apr. 10, 2025

(54) SIGNALING AND OPERATING METHOD AND DEVICE FOR ADAPTIVE FDSS

(71) Applicant: SAMSUNG ELECTRONICS CO., LTD., Suwon-si, Gyeonggi-do (KR)

(72) Inventors: Yosub PARK, Suwon-si (KR); Suhwook KIM, Suwon-si (KR); Seungil PARK, Suwon-si (KR); Bongsung SEO, Suwon-si (KR); Sangho LEE, Suwon-si (KR); Hyeondeok JANG, Suwon-si (KR)

(21) Appl. No.: 18/832,083

(22) PCT Filed: Dec. 26, 2022
(86) PCT No.: PCT/KR2022/021286

§ 371 Date: Jul. 22, 2024

(30) Foreign Application Priority Data
Jan. 24, 2022 (KR) 10-2022-0010045

(51) Int. Cl. H04W 72/1268; H04L 1/00; H04W 72/0453

(52) U.S. Cl. CPC H04W 72/1268; H04L 1/0003; H04W 72/0453

(57) ABSTRACT

The disclosure relates to a 5G or 6G communication system for supporting a data transmission rate higher than that of a 4G communication system such as LTE. A signaling method and device for operating adaptive frequency domain spectrum shaping (FDSS), according to various embodiments of the present disclosure, can be provided.

### TECHNICAL FIELD

The disclosure relates to a signaling method and device for adaptive frequency domain spectrum shaping (FDSS) operation.

### BACKGROUND ART

In looking back on the development processes with the repetition of the wireless communication generations, technologies for mainly human-targeted services, such as voice, multimedia, and data, have been developed. Connected devices, which are explosively on the rise after commercialization of the 5th generation (5G) communication system, have been expected to be connected to a communication network. Examples of things connected to the network may be vehicles, robots, drones, home appliances, displays, smart sensors installed in various kinds of infrastructures, construction machines, factory equipment, and the like. Mobile devices are expected to be evolved to various form factors, such as augmented reality glasses, virtual reality headsets, and hologram devices. In the 6th generation (6G), in order to provide various services through connection of hundreds of billions of devices and things with one another, efforts for developing an improved 6G communication system have been made. For this reason, the 6G communication system is called a “beyond 5G system”.

In the 6G communication system that is expected to be realized around 2030, the maximum transmission speed is tera (i.e., 1,000 giga) bps, and wireless latency is 100 microseconds (μ sec). That is, as compared with the 5G communication system, the transmission speed in the 6G communication system becomes 50 times faster, and the wireless latency is reduced to 1/10.

In order to accomplish such a high data transmission speed and ultra-low latency, implementation of the 6G communication system in terahertz bands (e.g., 95 gigahertz (95 GHz) to 3 terahertz (3 THz) bands) is being considered. In the terahertz bands, due to more severe path loss and atmospheric absorption phenomena than those in the millimeter wave (mmWave) bands introduced in the 5G, the importance of a technology to secure a signal reaching distance, that is, the coverage, is expected to become grower. As a primary technology to secure the coverage, it is required to develop a radio frequency (RF) element, antenna, more superior new waveform than the waveform of the orthogonal frequency division multiplexing (OFDM) in the coverage aspect, beamforming and massive multiple-input multiple-output (massive MIMO), full dimensional MIMO (FD-MIMO), array antenna, and multi-antenna transmission technology, such as large scale antenna technique. In addition, in order to improve the coverage of the terahertz band signals, new techniques, such as metamaterial-based lens and antenna, high-level spatial multiplexing technology using orbital angular momentum (OAM), and reconfigurable intelligent surface (0), are being discussed.

In addition, for frequency efficiency enhancement and system network improvement, in the 6G communication system, developments are under way in a full duplex technology in which an uplink and a downlink simultaneously utilize the same frequency resource at the same time, a network technology to integrally utilize a satellite and high-altitude platform station (HAPS), a network structure innovation technology to support a mobile base station and to enable network operation optimization and automation, a dynamic spectrum sharing technology through collision avoidance based on spectrum usage prediction, an AI-based communication technology to realize system optimization by utilizing artificial intelligence (AI) from a design stage and internalizing end-to-end AI support function, and a next-generation distributed computing technology to realize services having complexity that exceeds the limit of the UE operation capability by utilizing ultrahigh performance communication and computing resources (mobile edge computing (MEC), cloud, etc.). In addition, attempts are continuing to further strengthen connectivity between devices through designing of a new protocol to be used in the 6G communication system, implementation of hardware-based security environment, development of a mechanism for safe utilization of data, and technical development of a privacy maintaining method, to further optimize the network, to accelerate software of network entities, and to increase openness of the wireless communication.

By such researches and developments of the 6G communication system, it is expected that the next hyper-connected experience is possible through hyper-connectivity of the 6G communication system including not only connection between things but also connection between a human and a thing in all. Specifically, it is expected that services, such as truly immersive extended reality (XR), high-fidelity mobile hologram, and digital replica, can be provided through the 6G communication system. Further, since services, such as remote surgery, industrial automation, and emergency response through increasing security and credibility, can be provided through the 6G communication system, the 6G communication system will be applied to various fields, such as industry, medical treatment, automobile, and home appliances.

### DISCLOSURE OF INVENTION

### Technical Problem

An embodiment of the disclosure proposes a signaling method and operating method for applying adaptive frequency domain spectrum shaping (FDSS) in order to extremely lower a peak-to-average-power ratio (PAPR) or increase frequency transmission efficiency, when using OFDM considering discrete Fourier transform (DFT) precoding.

In addition, an embodiment of the disclosure proposes an FDSS-related parameter configuration and signaling method for data signals and control signals by combining a FDSS Filter length, a ratio of the number of symbols to be transmitted, and a FDSS filter type.

In addition, an embodiment of the disclosure also proposes a method for signaling whether FDSS capability is available between a base station and a terminal.

In addition, an embodiment of the disclosure also proposes a method for requesting FDSS when the terminal is not applying FDSS and a method for changing FDSS-related parameters when the terminal is applying FDSS.

The technical objects to be achieved by the disclosure are not limited to the technical objects mentioned above, and other technical objects not mentioned may be clearly understood by those skilled in the art from the following descriptions.

### Solution to Problem

In order to solve the above problems, a method performed by a base station in a wireless communication system according to an embodiment of the disclosure, may comprise determining scheduling information for transmitting uplink data to a terminal according to a link status of the terminal, determining frequency domain spectrum shaping (FDSS) parameter information according to the link status, and transmitting, to the terminal, the determined FDSS parameter information and the scheduling information.

In addition, the FDSS parameter information may include the information indicating the FDSS filter type and the index value indicating the information indicating the ratio of the length of the FDSS filter and the symbol length.

In addition, the transmitting, to the terminal, the determined FDSS parameter information and the scheduling information, may comprise transmitting, to the terminal, a mapping table including information indicating a FDSS filter type, information indicating a ratio of a length of the FDSS filter and a symbol length, and an index value indicating the information indicating the FDSS filter type and the ratio of the length of the FDSS filter and the symbol length; and transmitting, to the terminal, an index value corresponding to the FDSS parameter information determined based on the mapping table and the scheduling information.

In addition, the method may further comprise transmitting, to the terminal, information about whether the base station is able to receive a signal to which the FDSS is applied; and receiving, from the terminal, information about whether the terminal is able to transmit a signal by applying the FDSS.

In addition, the method may further comprise receiving, from the terminal, information requesting transmission of the FDSS parameter or information requesting change of the FDSS parameter.

In addition, in order to solve the above problems, a method performed by a terminal of a wireless communication system according to an embodiment of the disclosure may comprise receiving, from a base station, scheduling information for transmitting uplink data determined according to a link status of the terminal, and frequency domain spectrum shaping (FDSS) parameter information determined according to the link status; and applying the FDSS parameter information to the uplink data to transmit, to the base station, the uplink data according to the scheduling information.

In addition, the FDSS parameter information may include the information indicating the FDSS filter type and the index value indicating the information indicating the ratio of the length of the FDSS filter and the symbol length.

In addition, the receiving, from the base station, the FDSS parameter information and the scheduling information, may comprise receiving, from the base station, a mapping table including information indicating a FDSS filter type, information indicating a ratio of a length of the FDSS filter and a symbol length, and an index value indicating the information indicating the FDSS filter type and the ratio of the length of the FDSS filter and the symbol length; and receiving, from the base station, an index value corresponding to the FDSS parameter information determined based on the mapping table and the scheduling information.

In addition, the method may further comprise receiving, from the base station, information about whether the base station is able to receive a signal to which the FDSS is applied; and transmitting, to the base station, information about whether the terminal is able to transmit a signal by applying the FDSS.

In addition, the method may further comprise transmitting, to the base station, information requesting transmission of the FDSS parameter or information requesting change of the FDSS parameter.

In addition, in order to solve the above problems, a base station of a wireless communication system according to an embodiment of the disclosure may comprise a transceiver; and a controller that is connected to the transceiver, determines scheduling information for transmitting uplink data to a terminal according to a link status of the terminal, determines frequency domain spectrum shaping (FDSS) parameter information according to the link status, and transmits, to the terminal, the determined FDSS parameter information and the scheduling information.

In addition, in order to solve the above problems, a terminal of a wireless communication system according to an embodiment of the disclosure may comprise a transceiver; and a controller that is connected to the transceiver, receives, from a base station, scheduling information for transmitting uplink data determined according to a link status of the terminal, and frequency domain spectrum shaping (FDSS) parameter information determined according to the link status, and applies the FDSS parameter information to the uplink data to transmit, to the base station, the uplink data according to the scheduling information.

### Advantageous Effects of Invention

According to an embodiment of the disclosure, it is possible to provide a signaling method and operating method for applying adaptive frequency domain spectrum shaping (FDSS) in order to extremely lower a peak-to-average-power ratio (PAPR) or increase frequency transmission efficiency when using OFDM considering discrete Fourier transform (DFT) precoding.

In addition, according to an embodiment of the disclosure, it is possible to provide an FDSS-related parameter configuration and signaling method for data signals and control signals by combining a FDSS Filter length, a ratio of the number of symbols to be transmitted, and a FDSS filter type.

In addition, according to an embodiment of the disclosure, it is possible to provide a method for signaling whether FDSS capability of the base station and terminal is available.

In addition, according to an embodiment of the disclosure, it is possible to provide a method for requesting FDSS when the terminal is not applying FDSS and a method for changing FDSS-related parameters when the terminal is applying FDSS.

The effects that can be obtained from the disclosure are not limited to the effects mentioned above, and other effects not mentioned will be clearly understood by those skilled in the art from the description below.

### BRIEF DESCRIPTION OF DRAWINGS

FIG. 1 is a diagram illustrating a basic structure of a time-frequency domain, which is a radio resource domain where data or a control channel is transmitted in an LTE system, according to an embodiment of the disclosure.

FIG. 2 is a diagram illustrating a physical downlink control channel via which DCI is transmitted in an LTE system, according to an embodiment of the disclosure.

FIG. 3 is a diagram illustrating an example of transmission resources of a downlink control channel in a 5G wireless communication system, according to an embodiment of the disclosure.

FIG. 4 is a diagram illustrating an example of configuration for a control region in which a downlink control channel is transmitted in a 5G wireless communication system, according to an embodiment of the disclosure.

FIG. 5 is a diagram illustrating an example of configuration for a downlink RB structure in a 5G wireless communication system, according to an embodiment of the disclosure.

FIG. 6 is a diagram illustrating a data transmitter according to an embodiment of the disclosure.

FIG. 7 is a diagram illustrating a data receiver according to an embodiment of the disclosure.

FIG. 8 is a diagram illustrating an example of a table for configuring FDSS-related parameters when transmitting data, according to an embodiment of the disclosure.

FIG. 9 is a diagram illustrating an example of a procedure in which a base station transmits FDSS-related parameters to a terminal, according to an embodiment of the disclosure.

FIG. 10 is a diagram illustrating an example of a procedure in which a base station transmits FDSS-related parameters to a terminal, according to an embodiment of the disclosure.

FIG. 11 is a diagram illustrating an example of a procedure in which a base station transmits FDSS-related parameters to a terminal, according to an embodiment of the disclosure.

FIG. 12 is a diagram illustrating an example of a table for configuring FDSS-related parameters when transmitting a control signal, according to an embodiment of the disclosure.

FIG. 13 is a diagram illustrating an example of signaling for adaptive FDSS, according to an embodiment of the disclosure.

FIG. 14 is a diagram illustrating an example of a method for a terminal to transmit FDSS capability information to a base station, according to an embodiment of the disclosure.

FIG. 15 is a diagram illustrating an example of a method for a base station to transmit FDSS capability information, according to an embodiment of the disclosure.

FIG. 16 is a diagram illustrating an example of a method for a terminal to request FDSS from a base station, according to an embodiment of the disclosure.

FIG. 17 is a diagram illustrating an example of a method for a terminal to request an FDSS parameter change, according to an embodiment of the disclosure.

FIG. 18 is a diagram illustrating an example of a method in which a base station processes a request for changing FDSS parameters of a terminal, according to an embodiment of the disclosure.

FIG. 19 is a diagram illustrating a structure of a terminal, according to an embodiment of the disclosure.

FIG. 20 is a diagram illustrating a structure of a base station, according to an embodiment of the disclosure.

### MODE FOR THE INVENTION

Hereinafter, preferred embodiments of the disclosure will be described in detail with reference to the accompanying drawings. In this case, it is to be noted that if possible, the same constituent elements are denoted by the same reference numerals in the accompanying drawings. Further, detailed explanation of the known functions and constitutions that may obscure the subject matter of the disclosure will be omitted.

The terms used in the disclosure are only used to describe specific embodiments, and are not intended to limit the scope of other embodiments. In describing the embodiments in the specification, explanation of technical contents that are well known in the technical field to which the disclosure pertains and are not directly related to the disclosure may be omitted. This is to transfer the subject matter of the disclosure more clearly without obscuring the same through omission of unnecessary explanations. A singular expression may include a plural expression unless they are definitely different in a context. All terms used herein, including technical and scientific terms, have the same meaning as those commonly understood by a person skilled in the art to which the disclosure pertains. Such terms as those defined in a generally used dictionary may be interpreted to have the meanings equal or similar to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

A wireless communication system has evolved from providing an initial voice-oriented service to a broadband wireless communication system that provides high-speed and high-quality packet data services, such as high speed packet access (HSPA) in 3GPP, long term evolution (LTE) or evolved universal terrestrial radio access (E-UTRA), LTE-advanced (LTE-A), LTE-pro, high rate packet data (HRPD) in 3GPP2, ultra-mobile broadband (UMB), and communication standards such as IEEE's 802.16e.

In the LTE system, which is a representative example of the broadband wireless communication system, in downlink (DL), an orthogonal frequency division multiplexing (OFDM) scheme is adopted, and in uplink (UL), a single carrier frequency division multiple access (SC-FDMA) scheme is adopted. Uplink refers to a radio link in which a terminal (user equipment (UE) or mobile station (MS)) transmits data or control signals to a base station (evolved node B (eNode B) or base station (BS)), and downlink refers to a radio link in which the BS transmits data or control signals to the UE. The above-described multiple access scheme allows the data or control information of each user to be distinguished by allocating and operating the time-frequency resources to which the data or control information for each user are to be transmitted do not overlap each other, that is, to establish orthogonality.

The 5G communication system, which is a communication system after LTE, must support services that simultaneously satisfy various requirements so that various requirements from users and service providers can be freely reflected. Services considered for the 5G communication system include enhanced mobile broadband (eMBB), massive machine type communication (mMTC), ultra-reliability low latency communication (URLLC), and the like.

The eMBB aims to provide more improved data transfer rates than those supported by existing LTE, LTE-A or LTE-Pro. For example, in the 5G communication system, the eMBB may be able to provide a peak data rate of 20 Gbps in the downlink and a peak data rate of 10 Gbps in the uplink from the viewpoint of one base station. In addition, the 5G communication system must provide the peak data rate and the increased user perceived data rate of the UE at the same time. In order to satisfy such a requirement, improved various transmission/reception technologies including a more advanced multi-antenna (multiple-input multiple-output, (MIMO)) transmission technology are required. In addition, in the LTE system, a signal is transmitted using a transmission bandwidth of up to 20 MHz in the 2 GHz band, whereas the 5G communication system can satisfy the data transmission rate required by the 5G communication system by using a frequency bandwidth wider than 20 MHz in a frequency band of 3 to 6 GHz or 6 GHz or more.

At the same time, mMTC is being considered to support application services such as the Internet of Things (IoT) in the 5G communication system. In order to efficiently provide the Internet of Things, mMTC requires access support for large-scale UEs within a cell, improvement of coverage of UEs, improved battery life, and reduction of costs of UEs. Because the Internet of Things is attached to various sensors and various devices to provide communication functions, the IoT must be able to support many UEs (e.g., 1,000,000 UEs/km²) within a cell. In addition, because a UE supporting mMTC is highly likely to be in a shaded area that a cell cannot cover, such as the basement of a building, due to the nature of the service, wider coverage compared to other services provided by the 5G communication system may be required. A UE supporting mMTC must be composed of a low-cost UE, and because it is difficult to frequently exchange the battery of the UE, a very long battery lifetime of 10 to 15 years may be required.

Lastly, URLLC is a cellular-based wireless communication service used for a specific purpose (mission-critical). For example, services used for remote control of a robot or machinery, industrial automation, an unmanned aerial vehicle, remote health care, an emergency alert, etc. may be considered. Therefore, the communication provided by URLLC must provide very low latency and very high reliability. For example, a service supporting URLLC must satisfy the air interface latency of less than 0.5 milliseconds and, at the same time, must satisfy the requirement of a packet error rate of 10's or less. Therefore, for a service supporting URLLC, the 5G communication system must provide a transmit time interval (TTI) that is smaller than that of other services, and at the same time, design requirements for allocating wide resources in the frequency band to secure the reliability of the communication link may be required.

The three services of the 5G, i.e., eMBB, URLLC, and mMTC, may be multiplexed and transmitted in one system. In this case, different transmission/reception techniques and transmission/reception parameters may be used between services to satisfy different requirements of each service.

Hereinafter, a frame structure of the LTE or LTE-A system will be described in more detail with reference to the drawings.

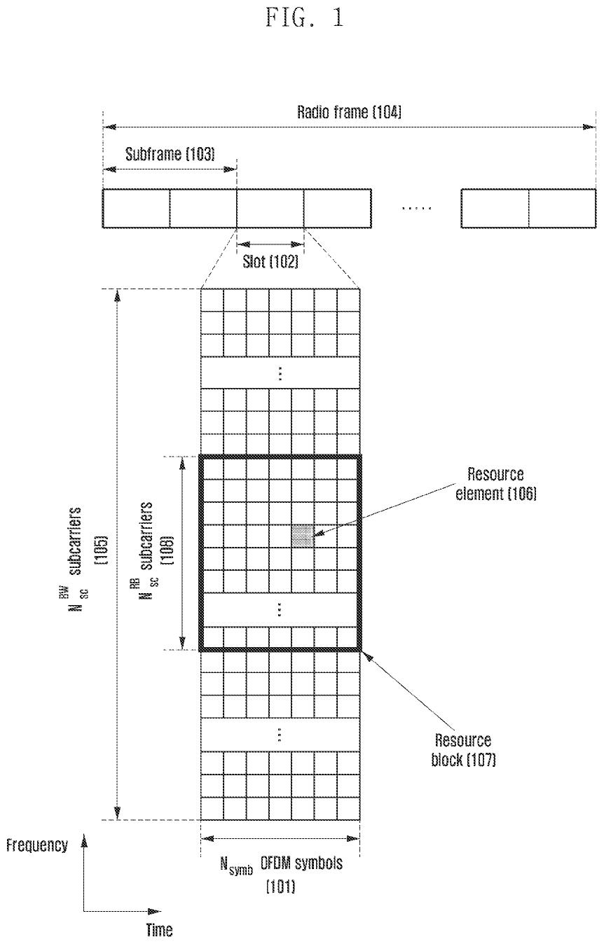

FIG. 1 is a diagram illustrating a basic structure of a time-frequency domain, which is a radio resource domain where data or a control channel is transmitted in the LTE system.

In FIG. 1, the horizontal axis represents a time domain and the vertical axis represents a frequency domain. With reference to FIG. 1, in the time domain, a minimum transmission unit is an OFDM symbol, and N_{symb} (101) OFDM symbols may constitute one slot 102 and two slots may constitute one subframe 103. A length of the slot 102 is 0.5 ms, and a length of the subframe 103 is 1.0 ms. A radio frame 104 is a time domain unit including ten subframes 103. In the frequency domain, a minimum transmission unit is a subcarrier, and a bandwidth of an overall system transmission band may include a total of N_{BW} (105) subcarriers. A basic resource unit in the time-frequency domain is a resource element (RE) 106 and may be defined by an OFDM symbol index and a subcarrier index. A resource block (RB or physical resource block (PRB)) 107 may be defined by N_{symb} (101) continuous OFDM symbols in the time domain and N_{RB} (108) continuous subcarriers in the frequency domain. Accordingly, one RB 108 may include N_{symb}×N_{RB} REs 106. In general, a minimum transmission unit of data may be an RB. Generally, in the LTE system, N_{symb}=7, N_{RB}=12, and N_{BW} and N_{RB} may be proportional to the bandwidth of the system transmission band.

Next, downlink control information (DCI) in the LTE or LTE-A system will be described in detail.

In the LTE system, scheduling information for DL data or UL data is transmitted from a base station to a terminal through DCI. Various formats may be defined for the DCI, and thus, defined DCI formats may be applied according to whether the scheduling information is for UL data or DL data, whether the DCI is compact DCI having small control information, whether spatial multiplexing using multiple antennas is applied, or whether the DCI is for power control. For example, DCI format 1, which is scheduling control information for DL data, may be constituted to include the following control information.
Resource allocation type 0/1 flag: notifies whether a resource allocation type is type 0 or type 1. The type 0 allocates resources in resource block group (RBG) units by applying a bitmap scheme. In the LTE system, a basic unit of scheduling is a resource block (RB) expressed by time and frequency domain resources, and an RBG includes a plurality of RBs and is used as a basic unit of scheduling in the type 0. The type 1 allocates a predetermined RB in an RBG.
Resource block assignment: notifies an RB allocated for data transmission. A resource represented according to a system bandwidth and a resource allocation scheme is determined.
Modulation and coding scheme (MCS): notifies a modulation scheme used for data transmission and a size of a transport block that is data to be transmitted.
HARQ process number: notifies a process number of an HARQ.
New data indicator: notifies whether transmission is HARQ initial transmission or re-transmission.
Redundancy version: notifies a redundancy version of an HARQ.
Transmit power control (TPC) command for physical uplink control channel (PUCCH): notifies a TPC command for a PUCCH that is an uplink control channel.

The DCI may be transmitted through a physical downlink control channel (PDCCH) through channel coding and modulation.

Acyclic redundancy check (CRC) may be attached to the payload of a DCI message, and may be scrambled by a radio network temporary identifier (RNTI) corresponding to terminal identity. Different RNTIs may be used according to the purpose of the DCI message, e.g., UE-specific data transmission, power control command, or random access response. Soon, the RNTI may not be explicitly transmitted but may be transmitted by being included in a CRC computation process. Upon receiving the DCI message transmitted onto the PDCCH, the terminal may identify the CRC by using the allocated RNTI, and when an identification result of the CRC is correct, the terminal may determine that the DCI message is transmitted to the terminal.

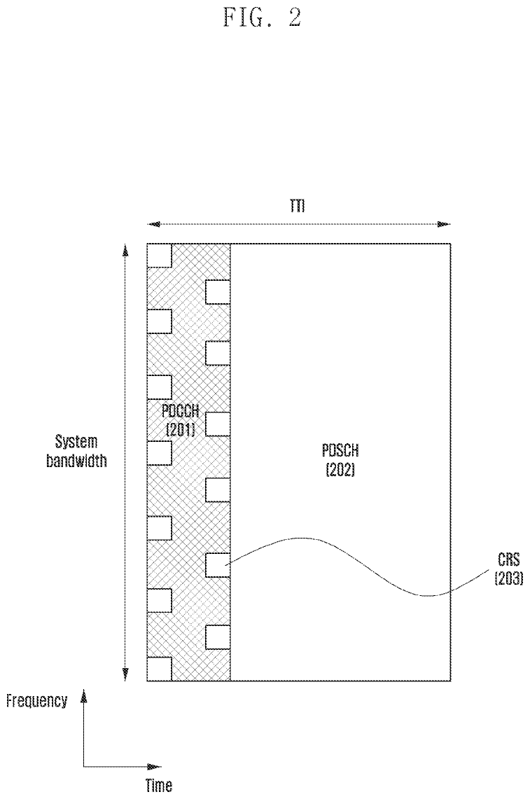

FIG. 2 is a diagram illustrating a physical downlink control channel via which DCI is transmitted in an LTE system, according to an embodiment of the disclosure.

With reference to FIG. 2, a PDCCH 201 may be time-multiplexed with a physical downlink shared channel (PDSCH) 202 that is a data transmission channel, and may be transmitted over an overall system bandwidth. A region for the PDCCH 201 may be represented with the number of OFDM symbols, which may be indicated to a terminal by a control format indicator (CFI) transmitted through a physical control format indicator channel (PCFICH). The PDCCH 201 may be allocated to the OFDM symbols, which are positioned in the head of a subframe, so that the terminal may decode DL scheduling allocation as soon as possible, and thus, there is an advantage that decoding latency for a downlink shared channel (DL-SCH), that is, overall DL transmission latency, may be reduced. Because one PDCCH 201 may carry one DCI message and multiple terminals may be simultaneously scheduled for a DL and a UL, multiple PDCCHs 201 may be simultaneously transmitted in each cell. A cell-specific reference signal (CRS) 203 may be used as a reference signal for decoding the PDCCH 201. The CRS 203 may be transmitted in each subframe over an entire band and scrambling and resource mapping may vary according to cell identity (ID). UE-specific beamforming may not be used because the CRS 203 is a reference signal commonly used by all terminals. Accordingly, a multi-antenna transmission scheme for LTE PDCCH 201 may be limited to open loop transmit diversity. The number of CRS 203 ports may be implicitly known to the terminal from the decoding of a physical broadcast channel (PBCH).

The resource allocation of the PDCCH 201 may be based on a control-channel element (CCE), and one CCE may include nine resource element groups (REGs), namely, a total of 36 resource elements (REs). The number of CCEs required for a specific PDCCH 201 may be 1, 2, 4, or 8, and this may differ depending on the channel coding rate of the DCI message payload. As described above, the number of different CCEs is used to implement link adaptation of the PDCCH 201. The terminal should detect a signal in a state where it does not know information on the PDCCH 201, and in an LTE, a search space indicating a set of CCEs for blind decoding has been defined. The search space is composed of a plurality of sets at an aggregation level (AL) of each CCE, and it is not explicitly signaled, but is implicitly defined through a function by the terminal identity and the subframe number. In each subframe, the terminal performs decoding of the PDCCH 201 with respect to all possible resource candidates that can be made from the CCEs in the configured search space, and processes information declared as valid to the corresponding terminal through the CRC checking.

The search space is classified into a UE-specific search space and a common search space. Terminals of a specific group or all terminals may search the common search space of the PDCCH 201 in order to receive cell-common control information, such as dynamic scheduling of system information or a paging message. For example, scheduling allocation information of the DL-SCH for transmission of system information block (SIB)-1 including enterprise information of a cell may be received by searching the common search space of the PDCCH 201.

In LTE, the entire PDCCH region is composed of a logical set of CCEs, and includes a search space composed of a set of CCEs. The search space is classified into a common search space and a UE-specific search space. The search space for the LTE PDCCH is defined as in Table 1 below.

TABLE 1
The set of PDOCH candidates to monitor are defined in terms of search spaces, where a search space Sₖ^{(L)} at
aggregation level L ∈ (1, 2, 4, 8) is defined by a set of PDCCH candidates. For each serving cell on which
PDCCH is monitored, the CCEs corresponding to PDCCH candidate m of the search space Sₖ^{(L)} are given
by
L{(Yₖ + m′)mod└N_{CCE,k}/L┘} + t
where Yₖ is defined below, i = 0, . . . , L − 1. For the common search space m′ = m. For the PDCCH UE specific
search space, for the serving cell on which PDCCH is monitored, if the monitoring UE is configured with
carrier indicator field then m′ = m + M^{(L)} · n_{CI} where n_{CI} is the carrier indicator field value, else if the
monitoring UE is not configured with carrier indicator field then m′ = m, where m = 0, . . . , M^{(L)} − 1, M^{(L)} is
the number of PDCCH candidates to monitor in the given search space.
Note that the carrier indicator field value is the same as ServCellIndex.
For the common search spaces, Yₖ is set to 0 for the two aggregation levels L = 4 and L = 8.
For the UE-specific search space Sₖ^{(L)} at aggregation level L, the variable Yₖ is defined by
Yₖ = (A · Yₖ₋₁)modD
where Y₋₁ = n_{RNTI} ≠ 0, A = 39827, D = 65537 and k = └n₁/2┘, n₁ is the slot number within a radio frame,
The RNTI value used for n_{RNTI} is defined in subclause 7:1 in downlink and subclause 8 in uplink.

According to the above-mentioned definition of the search space for a PDCCH 201, the UE-specific search space is not explicitly signaled but is defined implicitly by a subframe number and a function associated with a UE identity. In other words, the fact that a UE-specific search space is changed depending on a subframe number means that the UE-specific search space may be changed over time. Through the above, a problem (a blocking problem) in which a predetermined UE is incapable of using a search space due to other UEs may be overcome. If any UE is not scheduled in the corresponding subframe because all CCEs that are examined by the corresponding UE are already used by other UEs scheduled in the corresponding subframe, such a problem may not occur in the next subframe since this search space changes over time. For example, although UE-specific search spaces of UE #1 and UE #2 partially overlap in a predetermined subframe, the overlap may be expected to be different in a subsequent subframe since a UE-specific search space is different for each subframe.

According to the above-described definition of the search space for a PDCCH, a common search space is defined as a set of CCEs agreed upon in advance since a group of UEs or all UEs need to receive a PDCCH. In other words, the common search space is not changed depending on a UE identity, a subframe number, or the like. Although the common search space is present for transmission of various system messages, the common search space may be used for transmitting control information of an individual UE. Through the above, the common search space may be used as a solution for the phenomenon in which a UE is not scheduled due to the lack of available resources in a UE-specific search space.

A search space is a set of candidate control channels including CCEs that a UE is supposed to attempt to decode on a given aggregation level. There are various aggregation levels for binding one, two, four, and eight CCEs into a single bundle, and thus a UE has a plurality of search spaces. In an LTE PDCCH, the number of PDCCH candidates that are to be monitored by a UE in a search space and are defined based on an aggregation level may be defined in the table 1 below.

TABLE 2

| Search space Sₖ^{(L)} | | | Number of PDCCH |
|---|---|---|---|
| | Aggregation | | candidates M^{(L)} |
| Type | level L | Size [in CCEs] | |
| UE-specific | 1 | 6 | 6 |
| | 2 | 12 | 6 |
| | 4 | 8 | 2 |
| | 8 | 16 | 2 |
| Common | 4 | 16 | 4 |
| | 0 | 16 | 2 |

According to Table 2, in the case of a UE-specific search space, aggregation levels {1, 2, 4, 8} are supported, and in this instance, there are {6, 6, 2, 2} PDCCH candidates, respectively. In the case of a common search space, aggregation levels {4, 8} are supported, and in this instance, there are {4, 2} PDCCH candidates, respectively. The common search space supports only aggregation levels {4, 8} in order to improve coverage characteristics, since a system message generally needs to arrive at the edge of a cell.

DCI transmitted in the common search space is defined only for a predetermined DCI format, such as 0/1A/3/3A/1C, corresponding to the purpose of power control or the like for a UE group or a system message. In the common search space, a DCI format involving spatial multiplexing is not supported. A downlink DCI format which is supposed to be decoded in a UE-specific search space may be changed depending on the transmission mode configured for the corresponding UE. The transmission mode is configured via RRC signaling, and thus a subframe number is not accurately defined in association with whether the corresponding configuration is effective for the corresponding UE. Therefore, the UE always performs decoding with respect to DCI format 1A, irrespective of the transmission mode, so as to operate in a manner in which communication is not lost.

In the above description, a method for transmitting or receiving a downlink control channel and downlink control information and a search space in legacy LTE and LTE-A have been described.

Hereinafter, a downlink control channel in the 5G communication system which is currently under discussion will be described in detail with reference to drawings.

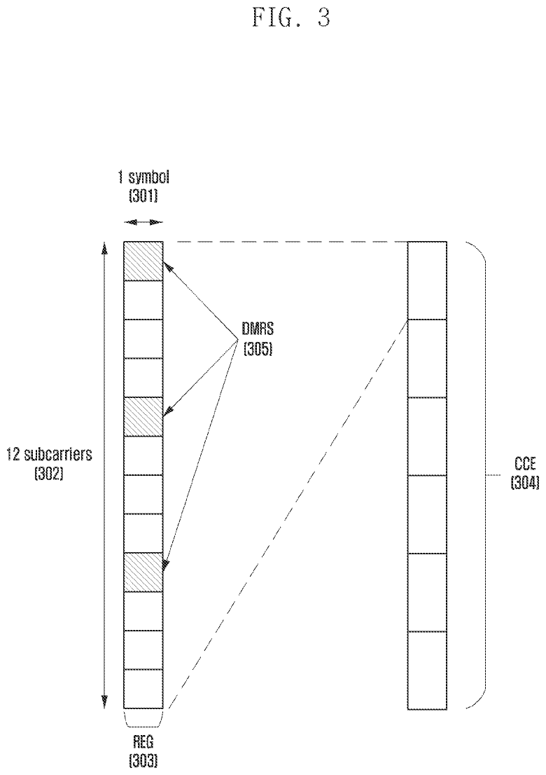

FIG. 3 is a diagram illustrating an example of transmission resources of a downlink control channel in a 5G wireless communication system, according to an embodiment of the disclosure.

With reference to FIG. 3, the basic unit (REG) of time and frequency resources configured for a control channel includes one OFDM symbol 301 on the time axis, and 12 subcarriers 302, that is, 1 RB, on the frequency axis. By assuming 1 OFDM symbol 301 as a basic time-axis unit when configuring the basic unit of a control channel, a data channel and a control channel may be time-multiplexed within a single subframe. By placing a control channel before a data channel, the processing time perceived by a user may be reduced, and thus, a latency requirement may be easily satisfied. The basic frequency-axis unit of a control channel is configured to 1 RB 302, and thus frequency multiplexing between a control channel and a data channel may be effectively performed.

According to an embodiment, by concatenating REGs 303 illustrated in FIG. 3, a control channel region may be configured in various sizes. For example, in case that the CCE 304 is a basic unit for allocation of a downlink control channel in 5G, 1 CCE 304 may include a plurality of REGs 303. A description will be provided with reference to the REG 303 illustrated in FIG. 3. If the REG 303 includes 12 REs and 1 CCE 304 includes 6 REGs 303, this means that 1 CCE 304 includes 72 REs. If a downlink control region is configured, the corresponding region may include a plurality of CCEs 304, and a predetermined downlink control channel may be transmitted by being mapped to a single CCE or to a plurality of CCEs 304 in the control region, depending on the aggregation level (AL). The CCEs 304 in the control region may be distinguished by numbers, and the numbers may be assigned according to a logical mapping scheme.

The basic unit of the downlink control channel illustrated in FIG. 3, that is, the REG 303, may include both REs to which DCI is mapped and a region to which a demodulation reference signal (DMRS) 305, which is a reference signal for decoding the DCI, is mapped. As illustrated in FIG. 3, the DMRS 305 may be transmitted in 6 REs within 1 REG 303. For reference, the DMRS 305 is transmitted using precoding that is the same as that of a control signal mapped to the REG 303, and thus a UE may be capable of decoding control information without information associated with precoding that a base station uses.

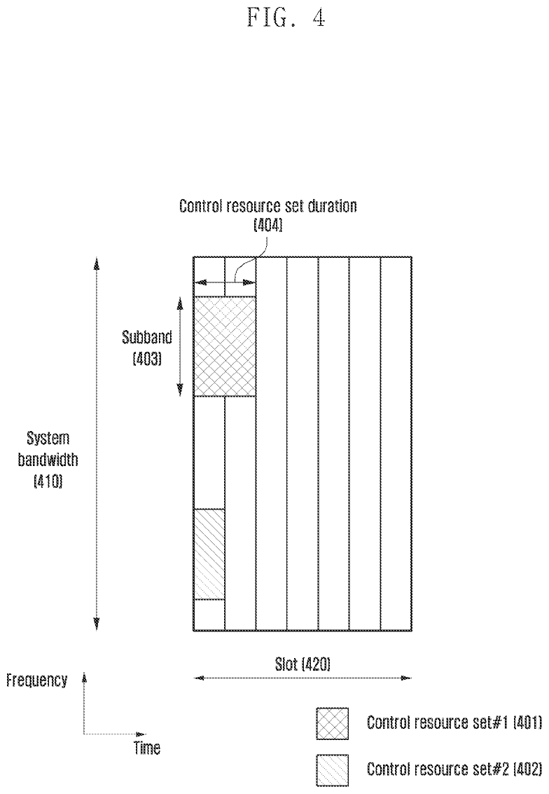

FIG. 4 is a diagram illustrating an example of a configuration for a control region (a control resource set (CORESET)) in which a downlink control channel is transmitted in a 5G wireless communication system, according to an embodiment of the disclosure.

FIG. 4 illustrates an example in which two control regions (control region #1 401 and control region #2 402) are configured within a system bandwidth 410 on the frequency axis and 1 slot 420 on the time axis (e.g., an example in FIG. 4 assumes that 1 slot includes 7 OFDM symbols). The control region 401 or 402 may be configured based on a predetermined subband 403 of the entire system bandwidth 410 on the frequency axis. On the time axis, the control region 401 or 402 may be configured based on one or plurality of OFDM symbols, which may be defined as a control region length (control resource set duration 404). In the example of FIG. 4, control region #1 401 is configured based on a control region length of 2 symbols, and control region #2 402 is configured based on a control region length of 1 symbol.

The control region in 5G, as described above, may be configured via higher-layer signaling (e.g., system information, master information block (MIB), RRC signaling) from a BS to a UE. Configuring a control region for a UE is providing information about the location of the control region, a subband, resource allocation of the control region, a control region length, and the like. For example, the information may include at least one of the following information shown in Table 3.

```
TABLE 3
    Configuration information 1. RB allocation information on frequency axis
    Configuration information 2. Control region start symbol
    Configuration 3. Control region symbol length
    Configuration 4. REG bundling size (2 or 3 or 6)
    Configuration 5. Transmission mode (interleaved transmission scheme or non-
interleaved transmission scheme)
    Configuration information 6. DMRS configuration information (precoder
granularity)
    Configuration information 7. Search space type (common search space, group-
common search space, UE-specific search space)
    Configuration information 8. DCI format to be monitored in corresponding
control region
    Other
```

In addition to the above-described configuration information in Table 3 above, various types of information required for transmitting a downlink control channel may be configured for a UE.

Next, downlink control information (DCI) in a 5G system will be described in detail.

In the 5G system, scheduling information about uplink data (physical uplink shared channel (PUSCH)) or downlink data (physical downlink shared channel (PDSCH)) may be transferred from a BS to a UE via DCI. The UE may monitor a DCI format for fallback and a DCI format for non-fallback in association with a PUSCH or PDSCH. The fallback DCI format may be implemented as a fixed field between a BS and a UE, and the non-fallback DCI format may include a configurable field.

The fallback DCI that schedules a PUSCH may include, for example, at least one of the information shown in Table 4 below,

TABLE 4
Identifier for DCI formats - [1] bit
Frequency domain resource assignment -[┌log₂ (N_{RB}^{UL,BWP}
(N_{RB}^{UL,BWP} + 1)/2)┐] bits
Time domain resource assignment - X bits
Frequency hopping flag - 1 bit.
Modulation and coding scheme - [5] bits
New data indicator - 1 bit
Redundancy version - [2] bits
HARQ process number - [4] bits
TPC command for scheduled PUSCH - [2] bits
UL/SUL indicator - 0 or 1 bit

The non-fallback DCI that schedules a PUSCH may include, for example, at least one of the information shown in Table 5 below.

```
TABLE 5
Carrier Indicator - 0 or 3 bits
Identifier for DCI formats - [1] bits
Bandwidth part indicator - 0, 1 or 2 bits
Frequency domain resource assignment
  For resource allocation type 0, ┌N_{RB}^{UL,BWP}/P┐ bits
  For resource allocation type 1, ┌log₂(N_{RB}^{UL,BWP}(N_{RB}^{UL,BWP} + 1)/2)┐ bits
Time domain resource assignment - 1, 2, 3, or 4 bits
VRB-to-PRB mapping - 0 or 1 bit, only for resource allocation type 1.
  0 bit if only resource allocation type 0 is configured;
  1 bit otherwise.
Frequency hopping flag - 0 or 1 bit, only for resource allocation type 1.
  0 bit if only resource allocation type 0 is configured;
  1 bit otherwise.
Modulation and coding scheme - 5 bits
New data indicator - 1 bit
Redundancy version - 2 bits as defined in section x.x of [6, TS38.214]
HARQ process number - 4 bits
1st downlink assignment index - 1 or 2 bits
  1 bit for semi-static HARQ-ACK codebook;
  2 bits for dynamic HARQ-ACK codebook with single HARQ-ACK
    codebook.
2nd downlink assignment index - 0 or 2 bits
  2 bits for dynamic HARQ-ACK codebook with two HARQ-ACK sub-
    codebooks;
  0 bit otherwise.
TPC command for scheduled PUSCH - 2 bits
$SRS resource indicator - \vert {log}_{2} ( \sum \text{?} ( \begin{matrix}{N}_{SRS} \\ k\end{matrix} ) ) \vert or ⌈ {log}_{2} ( {N}_{SRS} ) ⌉ bits$
$⌈ {log}_{2} ( \sum \text{?} ( \begin{matrix}{N}_{SRS} \\ k\end{matrix} ) ) ⌉ bits for non ‐ codecook based PUSCH transmission ;$
┌log₂(N_{SRS})┐ bits for codebook based PUSCH transmission.
Precoding information and number of layers - up to 6 bits
Antenna ports - up to 5 bits
SRS request - 2 bits
CSI request - 0, 1, 2, 3, 4, 5, or 6 bits
CBG transmission information - 0, 2, 4, 6, or 8 bits
PTRS-DMRS association - 2 bits.
beta_offset indicator - 2 bits
DMRS sequence initialization - 0 or 1 bit
UL/SUL indicator - 0 or 1 bit
$\text{?} \text{indicates text missing or illegible when filed}$
```

The fallback DCI that schedules a PDSCH may include, for example, at least one of the information shown in Table 6 below.

TABLE 6
Identifier for DCI formats - [1] bit
Frequency domain resource assignment -[┌log₂ (N_{RB}^{DL,BWP}
(N_{RB}^{DL,BWP} + 1)/2)┐] bits
Time domain resource assignment - X bits
VRB-to-PRB mapping - 1 bit.
Modulation and coding scheme - [5] bits
New data indicator - 1 bit
Redundancy version - [2] bits
HARQ process number - [4] bits
Downlink assignment index - 2 bits
TPC command for scheduled PUCCH - [2] bits
PUCCH resource indicator - [2] bits
PDSCH-to-HARQ feedback timing indicator - [3] bits

The non-fallback DCI that schedules a PDSCH may include, for example, at least one of the information shown in Table 7 below.

```
TABLE 7
    Carrier indicator - 0 or 3 bits
    Identifier for DCI formats - [1] bits
    Bandwidth part indicator - 0, 1 or 2 bits
    Frequency domain resource assignment
        For resource allocation type 0, ┌N_{RB}^{DL,BWP} / P┐ bits
        For resource allocation type 1, ┌log₂ (N_{RB}^{DL,BWP}
        (N_{RB}^{DL,BWP} + 1)/2)┐ bits
    Time domain resource assignment -1, 2, 3, or 4 bits
    VRB-to-PRB mapping - 0 or 1 bit, only for resource allocation
    type 1.
        0 bit if only resource allocation type 0 is configured;
        1 bit otherwise.
    PRB bundling size indicator - 1 bit
    Rate matching indicator - 0, 1, 2 bits
    ZP CSI-RS trigger - X bits
For transport block 1:
    Modulation and coding scheme - 5 bits
    New data indicator - 1 bit
    Redundancy version - 2 bits
For transport block 2:
    Modulation and coding scheme - 5 bits
    New data indicator - 1 bit.
    Redundancy version - 2 bits
    HARQ process number - 4 bits
    Downlink assignment index - 0 or 4 bits
    TPC command for scheduled PUCCH - 2 bits
    PUCCH resource indicator
    PDSCH-to-HARQ feedback timing indicator - 3 bits
    Antenna ports - up to 5 bits
    Transmission configuration indication - 3 bits
    SRS request - 2 bits
    CBG transmission information - 0, 2, 4, 6, or 8 bits
    CBG flushing out information - 0 or 1 bit
    DMRS sequence initialization - 0 or 1 bit
```

The DCI may be transmitted via a physical downlink control channel (PDCCH), after a channel-coding and modulation process. A cyclic redundancy check (CRC) is added to the payload of a DCI message, and the CRC may be scrambled with a radio network temporary identifier (RNTI) corresponding to a UE identity. Different RNTIs may be used depending on the purpose of the DCI message, for example, UE-specific data transmission, a power control command, a random-access response, or the like. That is, an RNTI is not explicitly transmitted, but is transmitted by being included in a CRC calculation process. If a UE receives a DCI message transmitted on a PDCCH, the UE may identify a CRC using an allocated RNTI. If the CRC identification result is correct, the UE may identify that the corresponding message is transmitted for the UE.

For example, a DCI that schedules a PDSCH associated with system information (SI) may be scrambled with a system information (SI)-RNTI. A DCI that schedules a PDSCH associated with a random-access response (RAR) message may be scrambled with a random-access (RA)-RNTI. A DCI that schedules a PDSCH associated with a paging message may be scrambled with a paging (P)-RNTI. A DCI that reports a slot format indicator (SFI) may be scrambled with an SFI-RNTI. A DCI that reports a transmit power control (TPC) may be scrambled with a TPC-RNTI. A DCI that schedules a UE-specific PDSCH or PUSCH may be scrambled with a cell RNTI (C-RNTI).

If a data channel, that is, a PUSCH or PDSCH, is scheduled for a predetermined UE via the PDCCH, data may be transmitted or received together with a DMRS within the corresponding scheduled resource region.

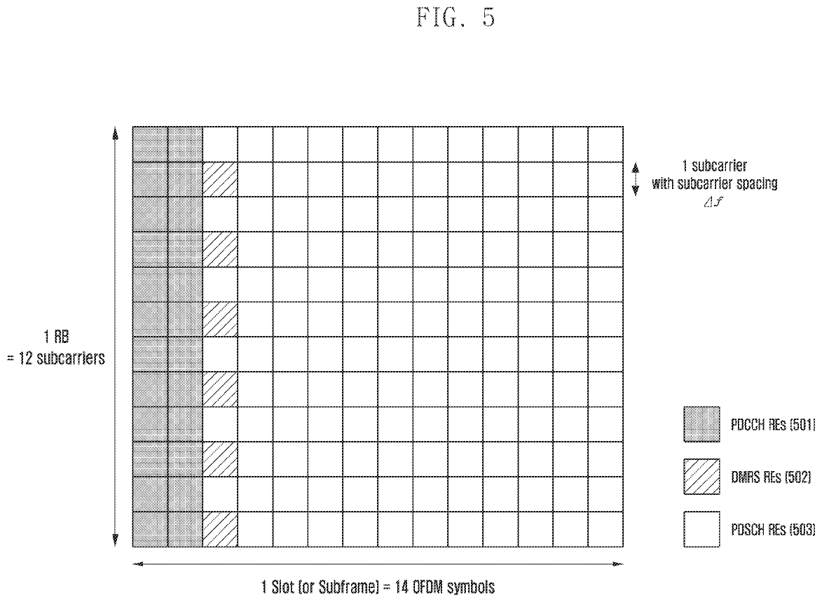

FIG. 5 is a diagram illustrating an example of configuration for a downlink RB structure in a 5G wireless communication system, according to an embodiment of the disclosure.

FIG. 5 illustrates a case configured such that a predetermined UE uses 14 OFDM symbols as a single slot (or subframe) in a downlink, a PDCCH is transmitted in the first two OFDM symbols, and a DMRS is transmitted in a third symbol. In the case of FIG. 5, in a predetermined RB in which a PDSCH is scheduled, the PDSCH may be transmitted by mapping data to REs via which a DMRS is not transmitted in a third symbol and then by mapping data to REs from the fourth to last symbols. A subcarrier spacing Δf expressed in FIG. 5 may be 15 kHz in the case of the LTE/LTE-A system, and may be one of {15, 30, 60, 120, 240, 480}kHz in the case of the 5G system.

Meanwhile, as described above, a BS needs to transmit a reference signal in order to measure a downlink channel state in a cellular system. In the case of the long-term evolution advanced (LTE-A) system of 3GPP, a UE may measure a channel state between a BS and the UE using a CRS or a channel state information reference signal (CSI-RS) transmitted by the BS. The channel state may need to be measured in consideration of various factors, and the amount of interference in a downlink may be included in the various factors. The amount of interference in a downlink may include an interference signal generated by an antenna that belongs to a neighboring BS, thermal noise, and the like. The amount of interference in a downlink is important when a UE determines a channel state in the downlink. For example, in case that a BS having a single transmission antenna transmits a signal to a UE having a single reception antenna, the UE needs to determine Es/Io by determining the energy per symbol capable of being received in the downlink and the amount of interference that is to be simultaneously received in the section where the corresponding symbol is received based on a reference signal received from the BS. The determined Ex/Io may be converted into a data transmission rate or a value corresponding thereto, may be transmitted to the BS in the form of a channel quality indicator (CQI), and the information that has transmitted to the BS may be used when the BS determines the data transmission rate to be used for transmission to the UE.

In the case of the LTE-A system, a UE feeds back information about a channel state of a downlink to a BS, so the BS utilizes the same for downlink scheduling. That is, the UE measures the reference signal that the BS transmits in the downlink, and feeds back, to the BS, information extracted from the measured reference signal in a form defined in the LTE/LTE-A standard. As described above, the information that the UE feeds back in LTE/LTE-A system is referred to as channel state information, and the channel state information may include at least one of the following three pieces of information.
Rand indicator (RI): indicates the number of spatial layers that a UE is capable of receiving in the current channel state.
Precoding matrix indicator (PMI): an indicator about a precoding matrix that a UE prefers in the current channel state.
Channel quality indicator (CQI): indicates the maximum data rate that a UE is capable of receiving in the current channel state.

The CQI may be replaced with a signal-to-interference-plus-noise ratio (SINR), a maximum error correction code rate and modulation scheme, a data efficiency per frequency, or the like, which may be utilized in a manner similar to a maximum data transmission rate.

The RI, PMI, and CQI are interrelated. For example, a precoding matrix supported in LTE/LTE-A may be defined differently for each rank. Therefore, a PMI value X when an RI is 1 and a PMI value X when an RI is 2 may be interpreted to be different. Also, a UE determines a CQI on the assumption that a PMI and RI that the UE reports to a BS are applied in the BS. That is, reporting RI_X, PMI_Y, and CQI_Z to the BS may be reporting that the corresponding UE is capable of performing reception at a data transmission rate corresponding to CQI_Z when a rank is RI_X and a PMI is PMI_Y. As described above, a UE calculates a CQI on the assumption of a transmission scheme to be performed with respect to a BS, so the UE may obtain the optimal performance when the UE actually executes transmission using the corresponding transmission scheme.

In LTE/LTE-A, the RI, PMI, and CQI, which are channel state information that a UE feeds back, may be fed back to the BS periodically or aperiodically. In the case in which a BS desires to aperiodically obtain channel state information of a predetermined UE, the BS may configure an aperiodic feedback (or aperiodic channel state information reporting) to be performed using an aperiodic feedback indicator (or a channel-state information request field or channel-state information request information) included in downlink control information (DCI) for the UE. Also, if the UE receives an indicator configured for aperiodic feedback, in an nth subframe, the UE may perform uplink transmission by including aperiodic feedback information (or channel state information) in data transmission in an n+kth subframe. Here, k is a parameter defined in the 3GPP LTE Release 11 standard, which is 4 in frequency-division duplexing (FDD) and may be defined as shown in Table 8 in the case of time-division duplexing (TDD).

TABLE 8

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | 7 | 4 | — | — | 6 | 7 | 4 |
| 1 | — | — | 6 | 4 | — | — | — | 6 | 4 | — |
| 2 | — | — | 4 | — | — | — | — | 4 | — | — |
| 3 | — | — | 4 | 4 | 4 | — | — | — | — | — |
| | — | — | 4 | 4 | — | — | — | — | — | — |
| 5 | — | — | 4 | — | — | — | — | — | — | — |
| 6 | — | — | 7 | 7 | 5 | — | — | 7 | 7 | — |

### k Value for Each Subframe Number n in TDD UL/DL Configuration

In the case in which aperiodic feedback is configured, feedback information (or channel state information) may include an RI, a PMI, and a CQI, and the RI and the PMI may not be fed back depending on a feedback configuration (or channel state report configuration) according to an embodiment.

Hereinafter, embodiments of the disclosure will be described in detail with reference to the accompanying drawings. Also, although an embodiment of the disclosure is described with reference to an LTE or LTE-A system, the embodiment of the disclosure may be applicable to other communication systems that have a similar technical background or use a similar channel type. For example, 5G mobile communication technology (5G, new radio (NR)) developed after LTE-A may be included. Also, embodiments of the disclosure may be modified by those skilled in the art without departing from the scope of the disclosure, and may be applied to other communication systems.

Also, in the following description of the disclosure, a detailed description of known functions or configurations incorporated herein will be omitted when the same may make the subject matter of the disclosure rather unclear. Also, the terms which will be described below are terms defined in consideration of the functions in the disclosure, and may be changed according to users, intentions of the users, or customs. Therefore, the definitions of the terms should be made based on the contents throughout the specification.

An embodiment of the disclosure proposes a signaling method and operating method for applying adaptive frequency domain spectrum shaping (FDSS) in order to extremely lower a peak-to-average-power ratio (PAPR) or increase frequency transmission efficiency, when using OFDM considering discrete Fourier transform (DFT) precoding. In addition, an embodiment of the disclosure proposes an FDSS-related parameter configuration and signaling method for data signals and control signals by combining a FDSS Filter length, a ratio of the number of symbols to be transmitted, and a FDSS Filter type. In addition, an embodiment of the disclosure also proposes a method for signaling whether FDSS capability between the BS and UE is possible. In addition, an embodiment of the disclosure also proposes a method for requesting FDSS when the UE is not applying FDSS and a method for changing FDSS-related parameters when the UE is applying FDSS.

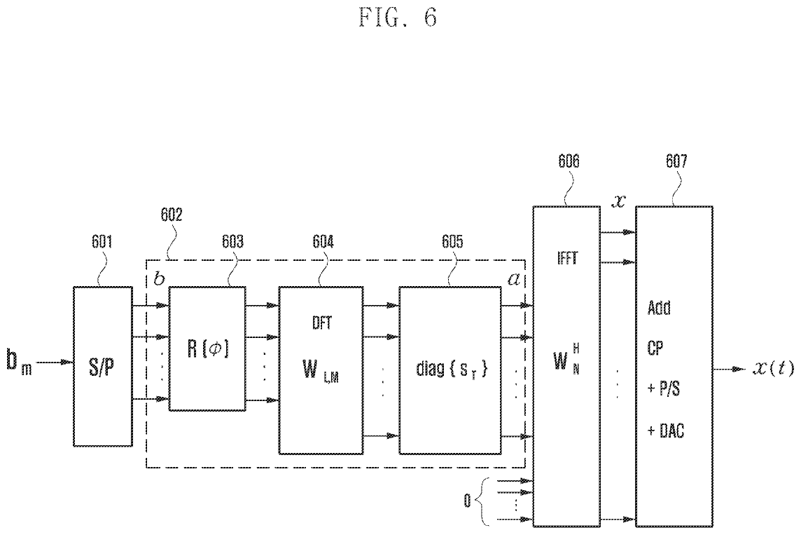

FIG. 6 is a diagram illustrating a data transmitter according to an embodiment of the disclosure.

FIG. 6 illustrates a process of generating a transmission signal at an FDSS transmitter that transmits a Pi-PAM or Pi/2-BPSK signal using DFT-S-OFDM. bₘ=(m=1, . . . , M) represents the M-length BPSK or PAM to be transmitted (601), and b=[b₁,b₂, . . . , bₘ] is formed as an M×1 vector through a serial-to-parallel process (602). Thereafter, b is multiplied by the constellation rotation matrix R(ϕ)=diag{[e^{jϕ-0}, e^{jϕ-1}, . . . , e^{jϕ-(M-1)}]}, through which in case of ϕ=π/2, the PAM signal is converted to Pi/2-PAM and the BPSK signal is converted to Pi/2-BPSK signal (603). Here, diag{[·]} is an operator that changes the internal vector [·] into a diagonal matrix. Thereafter, the signal is multiplied by the modified DFT matrix W_{L,M} for DFT precoding (604). Here, the size of the matrix W_{L,M} is L-by-M, and the (i, j) elements of the matrix are as the following Equation 1.

$${[ {W}_{LM} ]}_{( i , j )} = \frac{1}{\sqrt{M}} \text{?} , for 1 \leq i \leq L and 1 \leq j \leq M . \qquad [ Equation 1 ]$$

$$\text{?} \text{indicates text missing or illegible when filed}$$

Here, in case of L=M, it is the DFT matrix used in the existing DFT-S-OFDM, and in the disclosure, in case that the number of subcarriers (L) is smaller than the number of symbols (M), FDSS including the case of L<M and the opposite case of L>M is considered. Thereafter, the FDSS vector s_{T}=[s_{T,0}, s_{T,1}, . . . , s_{T,t-1}]^{T} is an L-by-1 vector and is multiplied for the signal to which DFT precoding has been applied (605). Depending on the use and purpose, the s_{T} value may be configured to various types of filter coefficients such as SRRC and RRC. Thereafter, the actual data multiplied by the FDSS vector is mapped to the L number before the input of a total N-point inverse fast Fourier transform (IFFT), the remaining N-L are zero-padded, and then, the N-point IFFT matrix W_{M}^{H} is multiplied to generate x (606). The time domain discrete transmission signal N-by-1 vector x generated in this way may be expressed as Equation 2 below.

$$x = {W}_{N}^{H} [ \begin{matrix}diag \{ {s}_{T} \} {W}_{L , M} R ( ϕ ) b \\ {0}_{N - L}\end{matrix} ] \qquad [ Equation 2 ]$$

Here, O_{N,L} is the zero vector of N-L-by-1. Thereafter, a cyclic prefix (CP) is inserted into the time domain discrete signal x, and through a parallel-to-serial process and a digital to analog converter (DAC), a time domain continuous transmission signal x(t) may be generated and transmitted through RF (607).

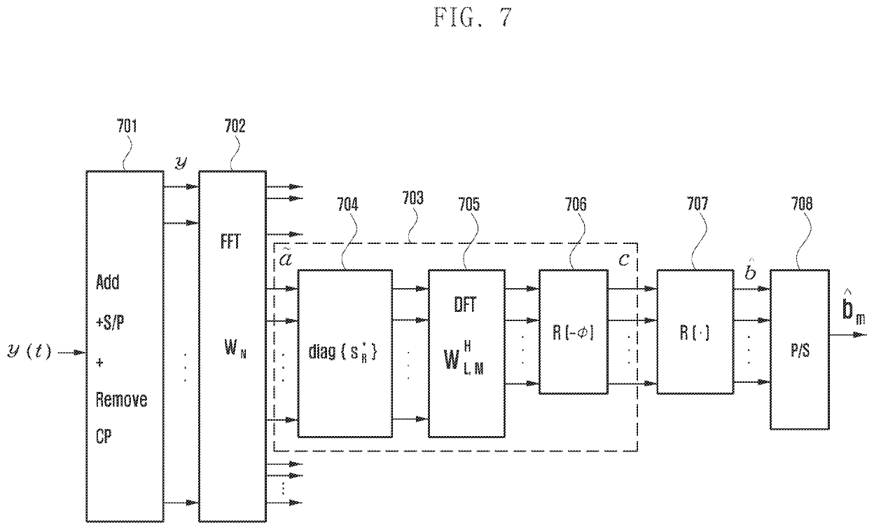

FIG. 7 is a diagram illustrating a data receiver according to an embodiment of the disclosure.

FIG. 7 illustrates a process of decoding a signal at a reception end where FDSS is applied to a Pi-PAM or Pi/2-BPSK signal using DFT-S-OFDM. The received signal y(t) undergoes the analog to digital converter (ADC) and serial-to-parallel conversion, and CP removal to generate a vector y of the received signal having N×1 size (701). N-point fast Fourier transform (FFT) is performed on the received signal vector y, and for this, an IFFT matrix W_{N} of N-by-N size is multiplied (702). Here, it is assumed that data is allocated to the first L subcarriers, only the values corresponding to the first L subcarriers may be extracted. After FFT, the signal vector [symbol] of size L-by-1 may be summarized as in [Equation 3] below (703).

$$\tilde{a} = \text{?} {W}_{N} y . \qquad [ Equation 3 ]$$

$$\text{?} \text{indicates text missing or illegible when filed}$$

Here, I_{L} is the unit matrix of size L-by-L, and O_{L×(N-L)} is the zero matrix of size L-by-(N-L). Thereafter, for the matched filtering process for the FDSS s_{T} of the transmitter and channel compensation in the frequency domain, s_{R} is multiplied, and s_{R}=diag{ĥ}sᵣ may be composed of the product of the diagonal matrix of the estimated frequency domain channel vector ĥ of L-by-1 size and the shaping vector s_{T} used at the transmitter (704). Here, ĥ may be estimated using channel estimation techniques such as MMSE or LS when mapping the reference signal just before the IFFT of the transmitter, and diag{ĥ}s_{T} may be estimated when mapping the reference signal before FDSS. After the channel compensation, the received signal is multiplied by W_{L,M}^{H}, which is an inverse discrete Fourier transform (IDFT) matrix of M-by-L size, and a DFT-despreading process is performed (705). Thereafter, de-rotation is performed on the phase rotation by ϕ at the transmitter end by multiplying by R(−ϕ) (706). Since the Pi/2-BPSK or Pi/2-PAM signal currently being considered is a signal that uses only the real axis, it passes through a part that takes only the real part, and the signal passed in this way corresponds to a vector \hat{b} of M-by-1 size (707), through the parallel-to-series process, \hat{b}ₘ(m=0, . . . , M-1) with complete detection may be finally generated (708).

Meanwhile, the main purpose of the FDSS technology is to enable more data to be transmitted with improved spectral efficiency (SE) from given radio resources, and expand (uplink) coverage by reducing PAPR and increasing (uplink) average transmission power.

In order to improve SE in such a system considering FDSS, the purpose may be achieved by increasing the number of subcarriers (L) larger than the number of symbols (M). Also, coverage may be expanded by making the number of symbols (M) to be smaller than the number of subcarriers (L). In other words, if the number of subcarriers or number that the UE uses for transmission and reception decreases or the number of symbols that the UE uses for transmission and reception increases, SE may increase, and if the number of subcarriers that the UE uses for transmission and reception increases, PAPR may decrease and coverage may increase.

For example, a first UE may perform transmission and reception through 36 symbols and 36 subcarriers, and a second UE may perform transmission and reception through 12 symbols and 12 subcarriers. In this case, the first UE may need to increase transmission efficiency (SE) of the first UE or increase the coverage of the second UE while maintaining similar performance.

In this case, in case that the first UE reduces the frequency (subcarrier) to perform transmission and reception through 36 symbols and 24 subcarriers, the PAPR of the first UE remains similar to the existing one and the same performance is achieved with fewer subcarriers. Alternatively, SE may be improved in case that the first UE performs transmission and reception through 48 symbols and 36 subcarriers. Also, in case that the second UE increases the frequency (subcarrier) to perform transmission and reception through 12 symbols and 24 subcarriers, the PAPR may be reduced (for example, reduced to almost 0 dB), and the second UE coverage may be increased. To this end, if the base station configures the FDSS filter for the first UE and second UE, the coverage of the second UE may be improved while maintaining the performance of the first UE.

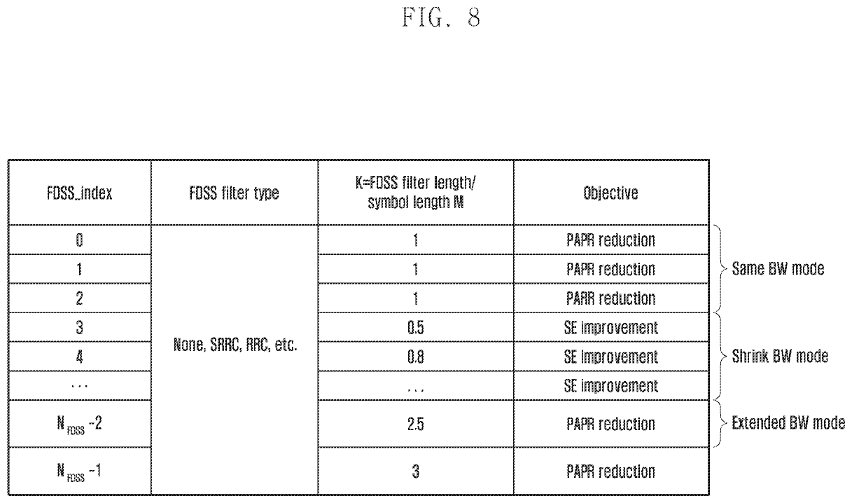

FIG. 8 is a diagram illustrating an example of a table for configuring FDSS-related parameters when transmitting data, according to an embodiment of the disclosure.

FIG. 8 is an example of a table (mapping table) showing FDSS_index, FDSS filter type, K (FDSS filter length L/symbol length M), and purpose for configuring various FDSS parameters.

For example, when a total of N_{FDSS} different FDSS configurations exist, as an example, FDSS_indexes 0, 1, and 2 may be configured to different FDSS filter types for the purpose of reducing PAPR and K=1 may be maintained.

In the case of FDSS_index numbers 3, 4, . . . , N_{FDSS}-3 it may be a configuration that changes simultaneously within the range of FDSS filter type and K<1 for the purpose of increasing transmission efficiency. In this case, the number (ratio) of subcarriers is reduced, so transmission efficiency (SE) may be increased. For example, in case that the number of terminals is large, the BS may reduce the number of subcarriers allocated to the UE. In addition, the base station may know that the UE is far away based on CSI feedback information received from the UE, and may configure FDSS parameters to increase transmission efficiency for distant UEs.

The last N_{FDSS}N_{FDSS}-1 FDSS_index does not place any restrictions on the type of FDSS filter for the purpose of reducing PAPR, and may be a configuration that changes within the range of K>1. In this case, the number (ratio) of subcarriers increases, which may have the effect of reducing PAPR and extending coverage.

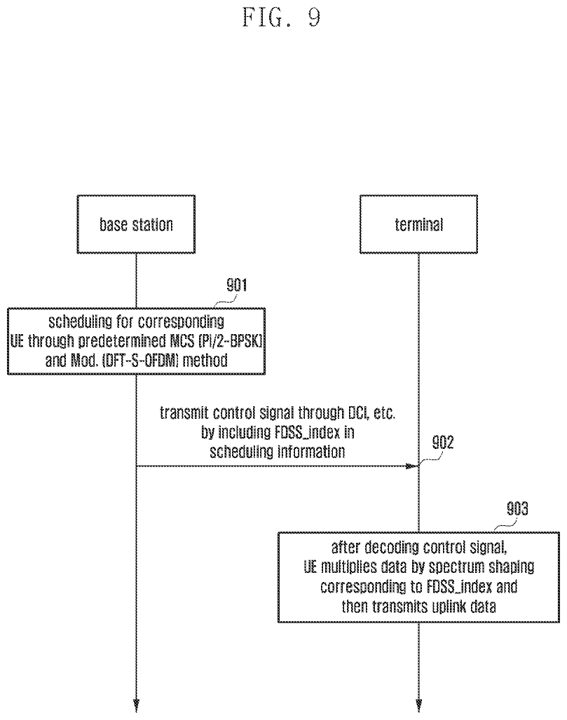

FIG. 9 is a diagram illustrating an example of a procedure in which a BS transmits FDSS-related parameters to a UE, according to an embodiment of the disclosure.

FIG. 9 is a process in which the BS signals the FDSS configuration to the UE based on the table illustrated in FIG. 8.

First, in operation 901, the BS may schedule to transmit uplink data through a predetermined MCS (for example, Pi/2-BPSK and DFT-S-OFDM) to the UE according to the link status (channel status, channel quality, link quality, resource status) of the UE. To this end, the BS may receive information about the link status from the UE.

Also, in operation 902, the BS may select an appropriate FDSS_index in FIG. 8 in consideration of the link status such as the current SNR and BLER of the UE, include the FDSS_index information in the DCI, etc., and transmit a control signal to the UE.

Thereafter, in operation 903, the UE may decode the control signal to obtain FDSS_index information configured in the BS, apply it to the uplink data using the corresponding FDSS filter and K value, and then transmit the uplink data to the BS.

Meanwhile, the table in which the FDSS-related parameters described in the part related to FIG. 8 are configured may be preconfigured between the UE and the BS. For example, before operation 901 or 902, the BS may constitute a table with FDSS-related parameters configured and transmit it to the UE. Alternatively, before operation 901 or 902, the UE may constitute a table with FDSS-related parameters configured and transmit it to the BS. Alternatively, a control message (signal) including the FDSS_index transmitted by the BS in operation 902 may also include the UE along with a table in which FDSS-related parameters are configured, and the control message may be transmitted to the UE.

Information about the table in which FDSS-related parameters are configured may be transmitted to the UE through system information (SIB) or broadcasting (PBCH), or may be transmitted to the UE through an RRC message or other UE-specific messages.

Alternatively, a table in which FDSS-related parameters are configured may be preconfigured in the UE and BS.

In case that it is necessary to change part or all of the table in which FDSS-related parameters are configured, a procedure for updating the table may be performed through signaling between the BS and the UE.

In the embodiment described later, the configuration of the table in which FDSS-related parameters are configured may be similarly applied.

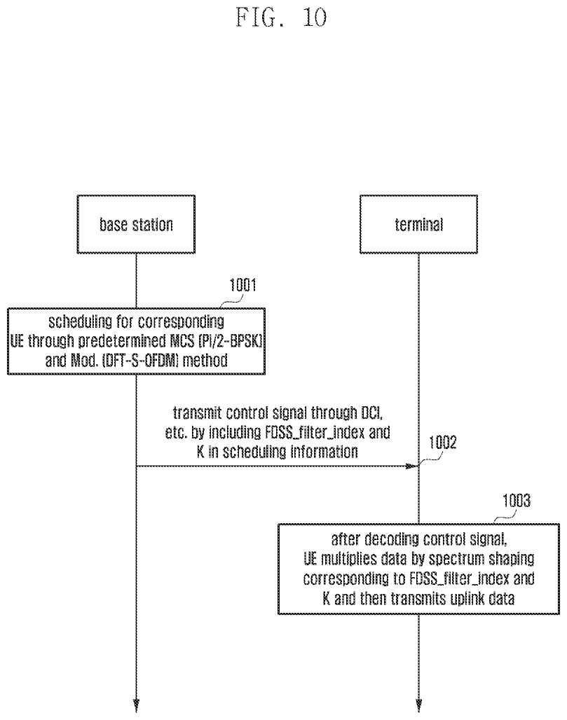

FIG. 10 is a diagram illustrating an example of a procedure in which a BS transmits FDSS-related parameters to a UE, according to an embodiment of the disclosure.

FIG. 10 is similar to FIG. 9, but is a process in which the BS signals each FDSS-related parameter to the UE.

First, in operation 1001, the BS may schedule uplink data to be transmitted to the UE through a predetermined MCS (for example, Pi/2-BPSK and DFT-S-OFDM) depending on the link status of the UE.

In operation 1002, the BS may transmit a control signal to the UE by including the FDSS_filter_index and K value indicating the appropriate FDSS filter type in the DCI, etc., considering the current link status such as SNR and BLER of the UE. Depending on the embodiment, the BS may transmit information indicating the type of the FDSS filter and the K value to the UE, rather than the index value of the FDSS filter. To do this, the BS may receive information about the link status from the UE.

Thereafter, in operation 1003, the UE may decode the control signal to obtain the FDSS_filter_index information and K value configured by the BS, use the corresponding FDSS filter and K value, apply them to the uplink data, and then, transmits the uplink data to the BS.

In this case, information about which FDSS filter the filter index (FDSS_filter_index) indicating the type of the FDSS filter represents (e.g., filter index and filter matching table) is predefined between the UE and the BS before operation 1001 or 1002. Alternatively, the BS or UE may constitute a matching table of the filter index and filter and transmit the matching table to the UE or BS before operation 1001 or operation 1002. Alternatively, the BS may transmit the matching table of the filter index and filter by including the matching table in a control signal (message) in operation 1002. In case that some or all of the configuration of the matching table of the filter index and filter need to be changed, an update procedure may be performed through signaling between the BS and the UE.

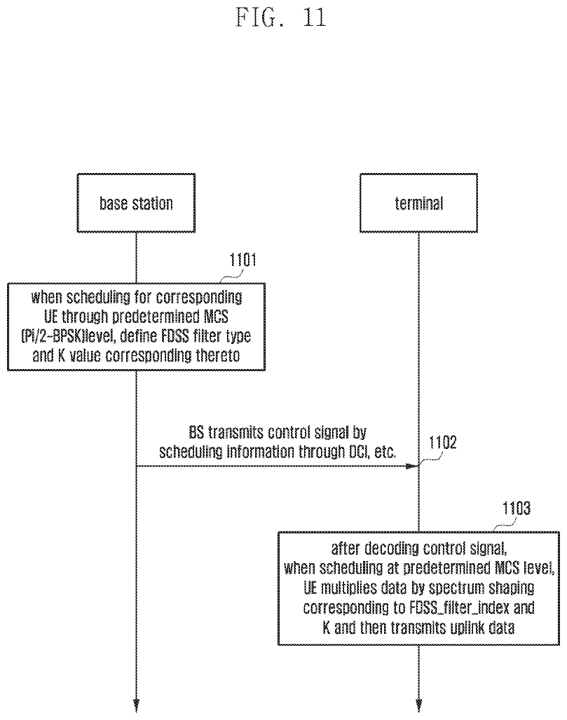

FIG. 11 is a diagram illustrating an example of a procedure in which a BS transmits FDSS-related parameters to a UE, according to an embodiment of the disclosure.

FIG. 11 is similar to FIG. 10, but is a process in which the BS signals the UE by coupling FDSS-related parameter information with scheduling information.

First, in operation 1101, in case that the BS schedules the UE to transmit uplink data to a predetermined MCS (e.g., Pi/2-BPSK and DFT-S-OFDM) according to the UE's link status, it may define the FDSS filter type and K value corresponding to the corresponding MCS level. To do this, the BS may receive information about the link status from the UE.

In operation 1102, the BS may transmit a control signal to the UE by including the corresponding scheduling information in the DCI.

Then, in operation 1103, the UE may decode the control signal to obtain FDSS filter information and K value coupled to the corresponding MCS level, use the corresponding FDSS filter and K value, apply them to uplink data, and then transmit the data.

In this case, the FDSS filter information and K value coupled to the MCS level (e.g., MCS level and filter-related parameters mapped thereto) may be predefined between the UE and the BS before operation 1101 or operation 1102. Alternatively, the BS or UE may constitute FDSS filter information and K value information coupled to the MCS level and transmit this to the UE or BS before operation 1101 or operation 1102. Alternatively, the BS may transmit FDSS filter information and K value information coupled to the MCS level by including them in a control signal (message) in operation 1102. In case that some or all of the configuration of the FDSS filter information and K value coupled to the MCS level need to be changed, an update procedure may be performed through signaling between the BS and the UE.

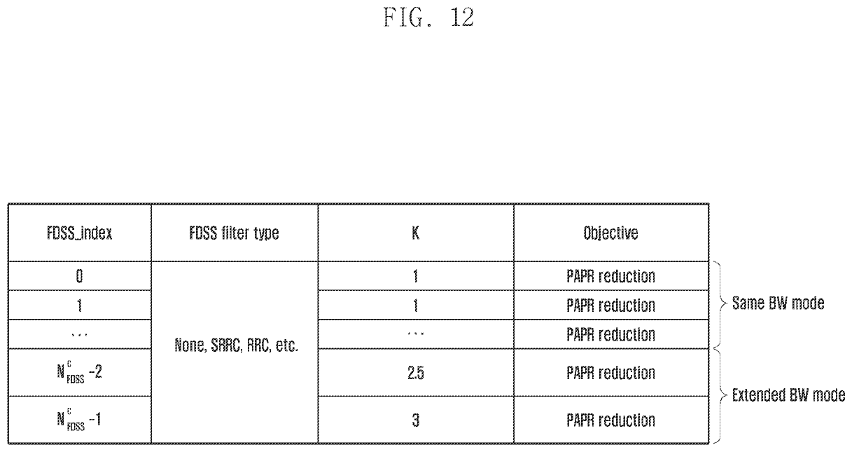

FIG. 12 is a diagram illustrating an example of a table for configuring FDSS-related parameters when transmitting a control signal, according to an embodiment of the disclosure.

FIG. 12 is an example of a table showing the FDSS_index, FDSS filter type, K (FDSS filter length L/symbol length M), and purpose required when applying FDSS to control signal transmission.

For example, when a total of N_{FDSS}^{c} different FDSS configurations exist, as an example, FDSS_index 0 and 1 may be differently configured for the FDSS filter type for the purpose of reducing PAPR and kept at K=1.

Furthermore, in case that the PAPR of the control signal is lowered more dramatically by using more bandwidth, the FDSS_index does not place any restrictions on the type of FDSS filter for the purpose of reducing PAPR, and may be a configuration that changes within the range of K>1. For example, by increasing the number (ratio) of subcarriers, PAPR may be reduced and coverage may be expanded.

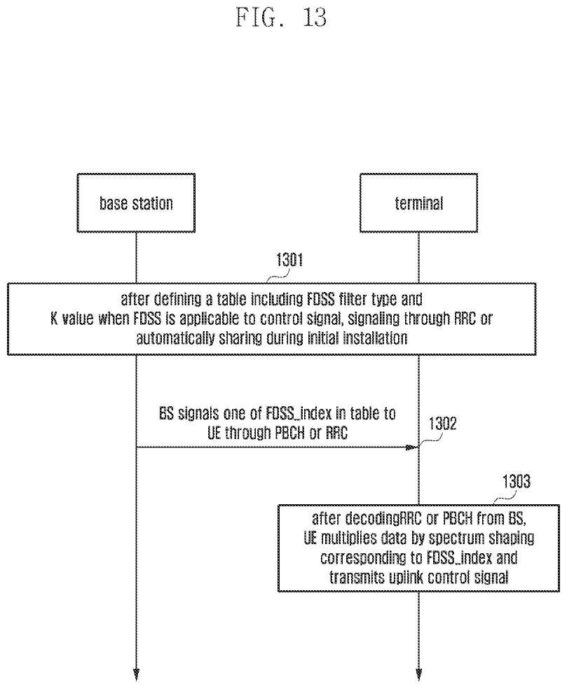

FIG. 13 is a diagram illustrating an example of signaling for adaptive FDSS according to an embodiment of the disclosure.

FIG. 13 shows the signaling process between the BS and the UE required when applying FDSS to the control signal.

First, in operation 1301, the BS defines a configuration including the FDSS filter type and K value available when applying FDSS to the control signal, as shown in the example illustrated in FIG. 12, and then may signal it to the UE through an RRC message, SIB, PBCH, etc. Alternatively, depending on the embodiment, the BS and the UE may automatically share a configuration including possible FDSS filter types and K values when applying FDSS to control signals during initial installation.

In operation 1302, the BS may select FDSS_index, one of the FDSS configurations, and signal it to the UE through a PBCH or RRC message.

Then, in operation 1303, the UE may transmit an uplink control signal by decoding the RRC message or PBCH received from the BS and then multiplying the FDSS corresponding to FDSS_index by the control signal to be transmitted.

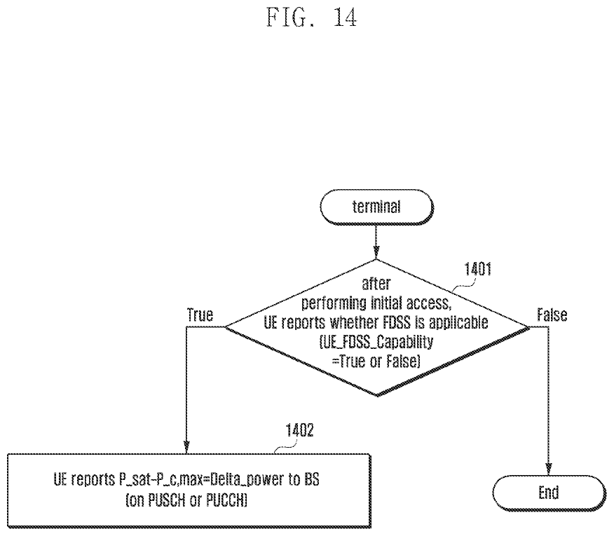

FIG. 14 is a diagram illustrating an example of a method for a UE to transmit FDSS capability information to a BS, according to an embodiment of the disclosure.

FIG. 14 shows the process of reporting to the BS whether the UE may perform FDSS.

In operation 1401, after performing initial access, the UE may report to the BS whether FDSS is possible through an uplink control channel. For example, information about whether the UE supports FDSS may be signaled to the BS as UE_FDSS_Capability (=True or False).

In case that the UE transmits UE_FDSS_Capability=True, in operation 1402, the UE may transmit, to the BS, Pₛₐₜ-Pₜᵣₐₙₛ=Δ_{power}, which is a value obtained by subtracting the maximum transmission power according to the UE standard from the saturation power of the power amplifier (PA), through PUSCH or PUCCH, in order for the BS to smoothly perform FDSS. Also, in case that the UE transmits UE_FDSS_Capability=False, the procedure may be terminated.

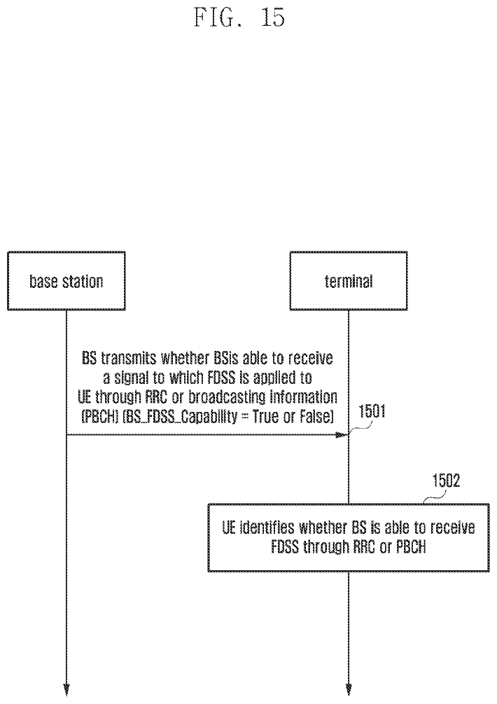

FIG. 15 is a diagram illustrating an example of a method for a BS to transmit FDSS capability information according to an embodiment of the disclosure.

FIG. 15 shows a process of informing the UE whether the BS may receive a signal to which FDSS is applied.

First, in operation 1501, the BS may transmit to the UE whether the BS may receive a signal to which FDSS is applied. In this case, information on whether the BS may receive a signal to which FDSS is applied may be included in an RRC message or broadcasting information (PBCH) and transmitted to the UE. Information on whether the BS may receive a signal to which FDSS is applied may be signaled to the UE as, for example, BS_FDSS_Capability (True or False).

In operation 1502, the UE may identify whether the BS is able to receive FDSS by decoding BS_FDSS_Capability information through an RRC message or PBCH. Also, depending on the identification result, the UE may request the BS to perform an operation according to FDSS.

Depending on the embodiment, after the embodiment illustrated in FIG. 15 is performed, the embodiment illustrated in FIG. 14 may be performed. That is, if the BS first transmits to the UE whether the BS may support FDSS, the UE may also report to the BS whether the UE may support FDSS. Alternatively, depending on the embodiment, the embodiment illustrated in FIG. 15 may be performed after the embodiment illustrated in FIG. 14 is performed. That is, when the UE first transmits to the BS whether the UE may support FDSS, the BS also transmits to the UE whether the BS may support FDSS, enabling the BS to perform a procedure according to FDSS in response to the request of the UE.

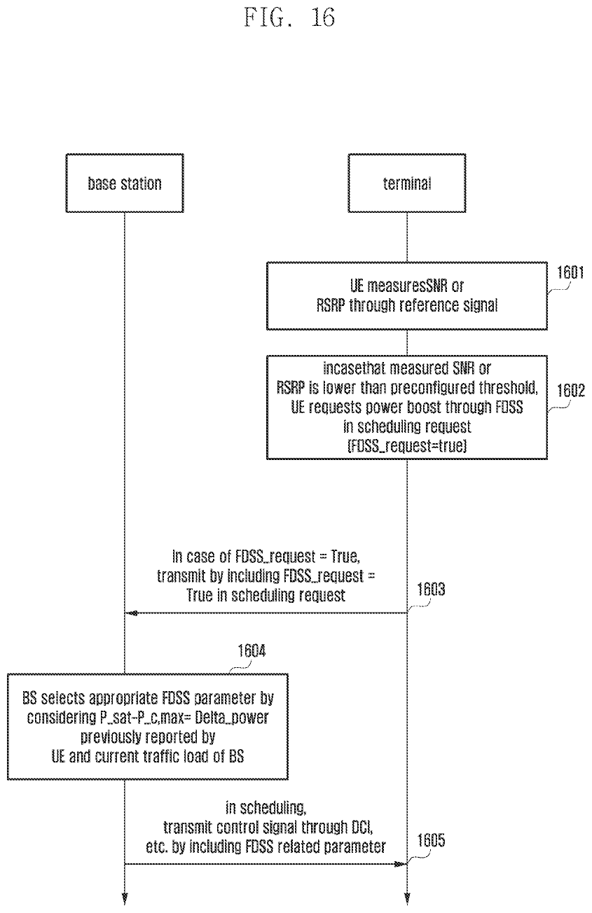

FIG. 16 is a diagram illustrating an example of a method for a UE to request FDSS from a BS according to an embodiment of the disclosure.

FIG. 16 shows a process in which the UE that is not using FDSS requests the BS to use FDSS (e.g., FDSS On).

First, in operation 1601, the UE may measure channel quality (channel status, link status, resource status) (e.g., SNR or RSRP value, etc.) through a reference signal, etc.

In operation 1602, in case that the measured channel quality (SNR or RSRP) is lower than a preconfigured (specific) threshold, the UE may request a transmission power boost through FDSS in the scheduling request. For example, this may include information requesting a transmission power boost through FDSS in the scheduling request. In this case, the information requesting a transmission power boost through the FDSS may be equal to FDSS_request=True.

In case that it is determined in operation 1602 to request a transmission power boost through FDSS, for example, in case of FDSS_request=True, the UE may include information requesting the use of FDSS (e.g., FDSS_request information (it may be configured as FDSS_request=True) in the scheduling request and transmit the same to the BS in operation 1603. Depending an embodiment, in case that the UE does not request FDSS, the UE may include information indicating that FDSS is not requested, for example, FDSS_request=False, in the scheduling request and transmit the scheduling request to the BS. Depending on an embodiment, in case that the FDDP_request field is included in the scheduling request message, the use of FDSS may be requested, and in case that the FDDP_request field is not included in the scheduling request message, the use of FDSS may not be requested.

In operation 1604, the BS may select appropriate FDSS parameters by considering Δ_{power} information (Pₛₐₜ-Pₜᵣₐₙₛ=Δ_{power}) previously transmitted by the UE and the current traffic load of the BS.

Also, in operation 1605, the BS may transmit the selected FDSS parameters to the UE by including them in a control signal through DCI, etc., as in the embodiments illustrated in FIGS. 9, 10, and 11 above.

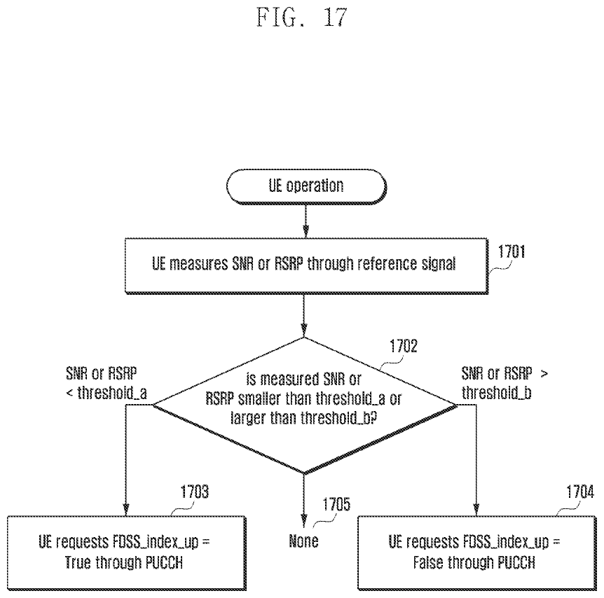

FIG. 17 is a diagram illustrating an example of a method for a UE to request an FDSS parameter change according to an embodiment of the disclosure.

FIG. 17 shows the operation of the UE using FDSS requesting the BS to change FDSS-related parameters.

First, in operation 1701, the UE may measure channel quality (channel status, link status, resource status) (for example, SNR or RSRP, etc.) through a reference signal, etc.

In addition, the UE may determine whether the channel quality (SNR or RSRP) measured in operation 1702 is less than a predetermined first threshold value (threshold_a).

As a result of the determination in operation 1702, in case that the measured channel quality is less than threshold_a, the UE may transmit information requesting to configure the FDSS parameter higher than the K value currently in use to the BS in operation 1703. Depending on an embodiment, in order to request FDSS parameter configuration to increase the currently used K value, the UE may signal FDSS_index_up=True to the BS through PUCCH.

Depending on an embodiment, it may be determined whether the channel quality (SNR or RSRP) measured in operation 1702 is greater than a preconfigured second threshold value (threshold_b). Depending on an embodiment, the second threshold value (threshold_b) may be greater than, the same as, or smaller than the first threshold value (threshold_a).

As a result of the determination in operation 1702, in case that the measured channel quality is greater than threshold_b, the UE may transmit information requesting to configure the FDSS parameter lower than the currently used K value to the BS in operation 1704. Depending on an embodiment, in order to request FDSS parameter configuration to reduce the currently used K value, the UE may signal FDSS_index_up=False to the BS through PUCCH. Alternatively, FDSS_index_down=True may be used as information to request a decrease in the currently used K value.

As a result of the determination in operation 1702, in case that the measured channel quality (SNR or RSRP) is between threshold_a and threshold_b, the UE may not make any request in operation 1705.

Depending on the embodiment, the information requesting FDSS parameter configuration to request a change in the K value currently in use may be 1-bit information (e.g., FDSS_index_modification), and in case that 0 is indicated, an increase in the K value is requested. In case that 1 is indicated, a decrease in the K value may be requested. Conversely, in case that 1 is indicated, an increase in the K value may be requested, and in case that 0 is indicated, a decrease in the K value may be requested.

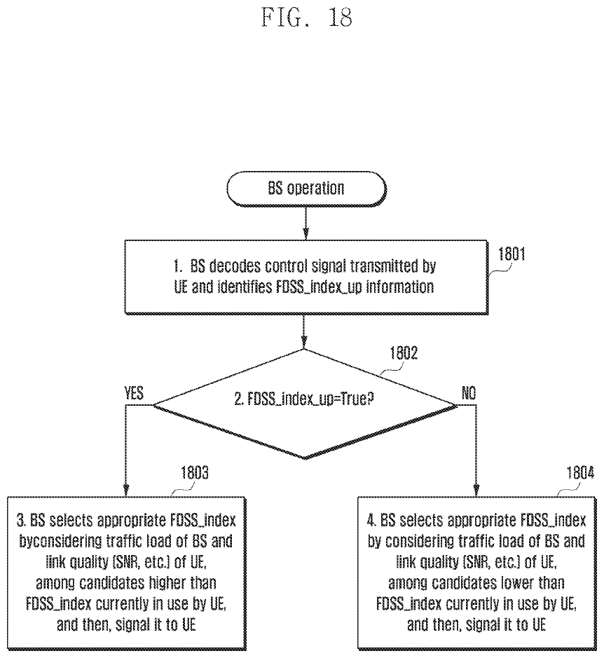

FIG. 18 is a diagram illustrating an example of a method in which a BS processes a request for changing FDSS parameters of a UE according to an embodiment of the disclosure.

FIG. 18 is a BS operation corresponding to the operation of the UE in FIG. 17 requesting to change FDSS-related parameters.

First, in operation 1801, the BS may determine whether the UE has requested a change to the FDSS parameter by decoding a message transmitted by the UE, for example, a control signal. For example, the BS may identify FDSS_index_up information, FDSS_index_down, or FDSS_index_modification included in the control message received from the UE.

Also, in operation 1802, the BS may identify whether the UE has requested a change to an FDSS parameter to increase the K value or the UE has requested a change to an FDSS parameter to decrease the K value.

In case that in operation 1802, the UE has requested a change to the FDSS parameter to increase the K value (for example, in case of FDSS_index_up=True), in operation 1803, the BS may select an appropriate FDSS_index by considering the traffic load of the BS and the link quality (SNR, etc.) of the UE, among the candidates higher than the FDSS_index currently in use by the UE, that is, the FDSS_indexes corresponding to a K value higher than the K value currently in use. Also, as in the embodiments illustrated in FIGS. 9, 10, 11, etc., FDSS-related parameters may be signaled to the UE.

In case that in operation 1802, the UE has requested a change to the FDSS parameter to decrease the K value (for example, in case of FDSS_index_up=False), in operation 1804, the BS may select an appropriate FDSS_index by considering the traffic load of the BS and the link quality (SNR, etc.) of the UE, among the candidates lower than the FDSS_index currently in use by the UE, that is, the FDSS_indexes corresponding to a K value lower than the K value currently in use. Also, as in the embodiments illustrated in FIGS. 9, 10, 11, etc., FDSS-related parameters may be signaled to the UE.

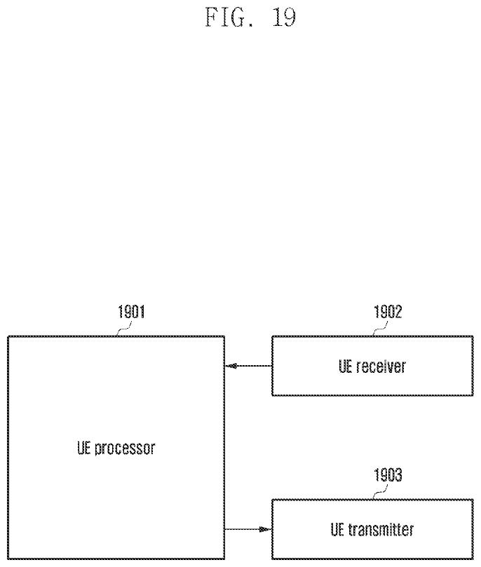

FIG. 19 is a diagram illustrating a structure of a UE according to an embodiment of the disclosure.

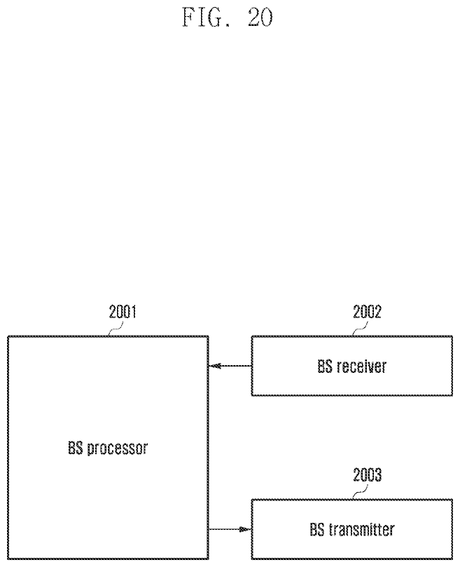

In order to perform the above embodiments of the disclosure, a transmitter, receiver, and controller of the UE and BS are illustrated in FIGS. 19 and 20, respectively. A method for transmission or reception by the BS and UE are shown in order to apply a method for transmitting or receiving a downlink control channel and a data channel in a communication system corresponding to the above embodiment. In order to perform the above method, a transmitter, receiver, and processor of the BS and UE should each operate according to an embodiment.

With respect to FIG. 19, the UE according to an embodiment of the disclosure may include a (UE) processor (control unit, controller, processor) 1901, a receiver 1902, a transmitter 1903, etc.

The UE processor 1901 may control a series of processes so that the UE may operate according to the above-described embodiment of the disclosure. For example, the UE processor 1901 may include a process of transmitting by applying the FDSS-related parameters specified by the BS of the disclosure, a process of reporting whether FDSS is possible, a process of requesting a change to the FDSS-related parameters, a process of requesting a new application of FDSS, etc.

The UE receiver 1902 and UE transmitter 1903 may be collectively referred to as a transceiver, communication unit, wireless communication unit, etc. in the embodiment of the disclosure. The transceiver 1902 or 1903 may transmit/receive signals with other network entities, such as a base station. The signal may include control information and data. To this end, the transceiver 1902 or 1903 may include an RF transmitter that up-converts and amplifies a frequency of a transmitted signal, an RF receiver that low-noise amplifies a received signal and down-converts a frequency thereof, and the like. In addition, the transceiver 1902 or 1903 may be connected to the UE processor 1901, receive a signal through a wireless channel and output the received signal to the UE processor 1901, and transmit a signal, which is output from the UE processor 1901, through a wireless channel. The transceiver 1902 or 1903 may include a transmission filter, a reception filter, an amplifier, a mixer, an oscillator, a digital to analog converter (DAC), an analog to digital converter (ADC), and the like. In addition, the transceiver 1902 or 1903 may include a plurality of RF chains. Further, the transceiver 1902 or 1903 may perform beamforming. For the beamforming, the transceiver 1902 or 1903 may adjust a phase and size of each of the signals transmitted or received through the plurality of antennas or antenna elements. Further, the transceiver 1902 or 1903 may perform MIMO, and may receive several layers during performing of a MIMO operation.

The UE processor 1901 may include at least one processor. For example, the UE processor 1901 may include a communication processor (CP) for controlling communication and an application processor (AP) controlling an upper layer such as an application program.

FIG. 20 is a block diagram illustrating a structure of a BS according to an embodiment of the disclosure.

With respect to FIG. 20, the BS according to an embodiment of the disclosure may include a BS processor (control unit, controller, processor) 2001, a receiver 2002, a transmitter 2003, and the like.

The BS processor 2001 may control a series of processes so that the base station may operate according to the above-described embodiment of the disclosure. For example, the BS processor 2001 may include a process of selecting appropriate FDSS parameters according to the UE status of the disclosure, a process of broadcasting whether the BS may receive FDSS, a process corresponding to a request for the UE to change the FDSS, and the like.

The BS receiver 2002 and BS transmitter 2003 may be collectively referred to as a transceiver, communication unit, wireless communication unit, etc. in the embodiment of the disclosure. The transceiver 2002 or 2003 may transmit/receive a signal to/from other network entities such as the UE. The signal may include control information and data. To this end, the transceiver 2002 or 2003 may include an RF transmitter that up-converts and amplifies a frequency of a transmitted signal, an RF receiver that low-noise amplifies a received signal and down-converts a frequency thereof, and the like. In addition, the transceiver 2002 or 2003 may be connected to the BS processor 2001, receive a signal through a wireless channel and output the received signal to the BS processor 2001, and transmit a signal, which is output from the BS processor 2001, through the wireless channel. The transceiver 2002 or 2003 may include a transmission filter, a reception filter, an amplifier, a mixer, an oscillator, a DAC, an ADC, and the like. In addition, the transceiver 2002 or 2003 may include a plurality of RF chains. Further, the transceiver 2002 or 2003 may perform beamforming. For the beamforming, the transceiver 2002 or 2003 may adjust a phase and size of each of the signals transmitted or received through the plurality of antennas or antenna elements. Further, the transceiver 2002 or 2003 may perform downlink MIMO operation by transmitting one or more layers.

The BS processor 2001 may include at least one processor. For example, the BS processor 2001 may include a communication processor (CP) for controlling communication and an application processor (AP) controlling an upper layer such as an application program.

It should be noted that structure diagrams, diagrams illustrating a control/data signal transmission method, operational procedures, and block diagrams depicted in FIGS. 1 to 20 are not intended to limit the scope of the disclosure. In other words, all the components, entities, or operations described above in FIGS. 1 to 20 should not be construed as being essential for the practice of the disclosure, and some of them may be sufficient to practice the disclosure without departing from the spirit of the disclosure.

The above-described operations of the network entity or UE may be realized by providing a memory device storing the corresponding program codes in a specific component of the network entity or UE device. That is, the controller of the network entity or UE device may perform the above-described operations by causing a processor or central processing unit (CPU) to read and execute the program codes stored in the memory device.

The various components and modules of the network entity, BS or UE described herein may be operated by using hardware circuit, for example, complementary metal oxide semiconductor based logic circuit, firmware, software, and/or hardware, and a combination of firmware and/or software inserted into a machine-readable medium. For example, various electrical structures and methods may be realized by using electrical circuits such as transistors, logic gates, or application specific integrated circuits.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary.

1. A method performed by a base station of a wireless communication system, comprising:
determining scheduling information for transmitting uplink data to a terminal according to a link status of the terminal;
determining frequency domain spectrum shaping (FDSS) parameter information according to the link status; and
transmitting, to the terminal, the determined FDSS parameter information and the scheduling information.

2. The method of claim 1, wherein the transmitting, to the terminal, the determined FDSS parameter information and the scheduling information, comprising:
transmitting, to the terminal, a mapping table including information indicating a FDSS filter type, information indicating a ratio of a length of the FDSS filter and a symbol length, and an index value indicating the information indicating the FDSS filter type and the ratio of the length of the FDSS filter and the symbol length; and
transmitting, to the terminal, an index value corresponding to the FDSS parameter information determined based on the mapping table and the scheduling information,
wherein the FDSS parameter information includes the information indicating the FDSS filter type and the index value indicating the information indicating the ratio of the length of the FDSS filter and the symbol length.

3. The method of claim 1, further comprising:
transmitting, to the terminal, information about whether the base station is able to receive a signal to which the FDSS is applied; and
receiving, from the terminal, information about whether the terminal is able to transmit a signal by applying the FDSS.

4. The method of claim 1, further comprising receiving, from the terminal, information requesting transmission of the FDSS parameter or information requesting change of the FDSS parameter.

5. A method performed by a terminal of a wireless communication system, comprising:
receiving, from a base station, scheduling information for transmitting uplink data determined according to a link status of the terminal, and frequency domain spectrum shaping (FDSS) parameter information determined according to the link status; and
applying the FDSS parameter information to the uplink data to transmit, to the base station, the uplink data according to the scheduling information.

6. The method of claim 5, wherein the receiving, from the base station, the FDSS parameter information and the scheduling information, comprising:
receiving, from the base station, a mapping table including information indicating a FDSS filter type, information indicating a ratio of a length of the FDSS filter and a symbol length, and an index value indicating the information indicating the FDSS filter type and the ratio of the length of the FDSS filter and the symbol length; and
receiving, from the base station, an index value corresponding to the FDSS parameter information determined based on the mapping table and the scheduling information,
wherein the FDSS parameter information includes the information indicating the FDSS filter type and the index value indicating the information indicating the ratio of the length of the FDSS filter and the symbol length.

7. The method of claim 5, further comprising:
receiving, from the base station, information about whether the base station is able to receive a signal to which the FDSS is applied; and
transmitting, to the base station, information about whether the terminal is able to transmit a signal by applying the FDSS.

8. The method of claim 5, further comprising transmitting, to the base station, information requesting transmission of the FDSS parameter or information requesting change of the FDSS parameter.

9. A base station of a wireless communication system, comprising:
a transceiver; and
a controller that is connected to the transceiver, determines scheduling information for transmitting uplink data to a terminal according to a link status of the terminal, determines frequency domain spectrum shaping (FDSS) parameter information according to the link status, and transmits, to the terminal, the determined FDSS parameter information and the scheduling information.

10. The base station of claim 9, wherein controller controls to transmit, to the terminal, a mapping table including information indicating a FDSS filter type, information indicating a ratio of a length of the FDSS filter and a symbol length, and an index value indicating the information indicating the FDSS filter type and the ratio of the length of the FDSS filter and the symbol length, and transmit, to the terminal, an index value corresponding to the FDSS parameter information determined based on the mapping table and the scheduling information,
wherein the FDSS parameter information includes the information indicating the FDSS filter type and the index value indicating the information indicating the ratio of the length of the FDSS filter and the symbol length.

11. The base station of claim 9, wherein the controller controls to transmit, to the terminal, information about whether the base station is able to receive a signal to which the FDSS is applied, receive, from the terminal, information about whether the terminal is able to transmit a signal by applying the FDSS, receive, from the terminal, information requesting transmission of the FDSS parameter or information requesting change of the FDSS parameter.

12. A terminal of a wireless communication system, comprising:
a transceiver; and
a controller that is connected to the transceiver, receives, from a base station, scheduling information for transmitting uplink data determined according to a link status of the terminal, and frequency domain spectrum shaping (FDSS) parameter information determined according to the link status, and applies the FDSS parameter information to the uplink data to transmit, to the base station, the uplink data according to the scheduling information.

13. The terminal of claim 12, wherein the controller controls to receive, from the base station, a mapping table including information indicating a FDSS filter type, information indicating a ratio of a length of the FDSS filter and a symbol length, and an index value indicating the information indicating the FDSS filter type and the ratio of the length of the FDSS filter and the symbol length, and receive, from the base station, an index value corresponding to the FDSS parameter information determined based on the mapping table and the scheduling information,
wherein the FDSS parameter information includes the information indicating the FDSS filter type and the index value indicating the information indicating the ratio of the length of the FDSS filter and the symbol length.

14. The terminal of claim 12, wherein the controller receives, from the base station, information about whether the base station is able to receive a signal to which the FDSS is applied, and transmits, to the base station, information about whether the terminal is able to transmit a signal by applying the FDSS.

15. The terminal of claim 12, wherein the controller transmits, to the base station, information requesting transmission of the FDSS parameter or information requesting change of the FDSS parameter.
